(19) United States
(12) Patent Application Publication
(10) Pub. No.: US 2004/0185384 A1
(43) Pub. Date: Sep. 23, 2004

(54) Image forming method and image exposure apparatus

(75) Inventors: Atsushi Suganuma, Kanagawa (JP); Hiroshi Sunagawa, Kanagawa (JP); Norio Aoshima, Shizuoka-ken (JP); Toshifumi Inno, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/804,041

(22) Filed: Mar. 19, 2004

(30) Foreign Application Priority Data
Mar. 20, 2003 (JP) 2003-77544
Mar. 20, 2003 (JP) 2003-77545

(51) Int. Cl. G03C 8/00

(52) U.S. Cl. 430/315

(57) ABSTRACT

The present invention provides an image forming method on a planographic printing plate precursor for plate-making in which an image is exposed to light by scanning with an infrared beam and which obviates development using any developing liquid, as well as an image exposure apparatus used in the method.

### CROSS-REFERENCE TO RELATED APPLICATION

This application claims priority under 35 USC 119 from Japanese Patent Application Nos. 2003-77544 and 2003-77545, the disclosures of which are incorporated by reference herein.

### BACKGROUND OF THE INVENTION

1. Field of the Invention

The present invention relates to an image forming method and an image exposure apparatus. More specifically, the invention relates to an image forming method on a planographic printing plate precursor for plate-making in which an image is exposed to light by scanning with an infrared beam and which obviates development using any developing liquid, as well as an image exposure apparatus used in the method.

2. Description of the Related Art

Due to remarkable progress of laser technology in recent years, solid-state or semiconductor lasers of small size having high output and capable of emitting an infrared beam with a wavelength ranging from 760 nm to 1,200 nm (hereinafter sometimes referred to as “infrared laser”) are readily available. Particularly in the field of planographic printing, such an infrared laser is very useful as a recording light source for a Computer to Plate (CTP) system in which a printing plate can directly be made based on digital data from a computer or the like.

Concomitant with the above-stated trends, extensive research has been made on the planographic printing plate for use in the CTP system. Particularly for the purpose of further streamlining the method and solving a problem of waste liquid generated, studies have been made on the planographic printing plate precursor to obviate a development process, namely, a post-exposure developing process which can be set into a printing machine. This has lead to a variety of methods being proposed.

An example of the method to eliminate such a development process is a so-called “on-machine developing method” which includes the steps of placing a post-exposure planographic printing plate precursor in a cylinder in a printing machine, and supplying a wetting solution and ink while rotating the cylinder so that the non-image portion can be removed from the plate. In such a process, the planographic printing plate precursor obtained after light exposure is placed in the printing machine, and plate-making is completed through an ordinary printing process. Such a process enables elimination of a liquid development process using a conventional developing agent, thereby a streamlining a pre-printing process, and further obviates a process of treating waste liquid generated.

For use in such a method, a type of planographic printing plate precursor is proposed which includes a substrate having disposed thereon a crosslinked hydrophilic layer containing a micro-encapsulated hot-melt material (for example, see a pamphlet of WO94/23954.) In this printing plate, microcapsules are decomposed at an area irradiated with a laser beam by the action of generated heat to thereby release a lipophilic material from the microcapsules, making a hydrophilic layer surface turn hydrophobic.

Other examples of proposed planographic printing plate precursors utilizing heat-decomposable microcapsules include those containing microcapsules in which a photo-polymerizable monomer and a photosensitive resin are encapsulated, and those including a three-dimensionally crosslinked hydrophilic layer and microcapsules containing a lipophilic component capable of interacting with the layer (for example, see Japanese Patent Application Laid-Open (JP-A) No. 62-250454 and Japanese Patent No. 3206297).

These planographic printing plate precursors do not need a developing process. However, when a metal plate having high thermal conductivity, such as an aluminum plate, is used as a support for the planographic printing plate precursor, heat applied for forming images diffuses into the support, whereby curing cannot progress sufficiently at an interface between the image recording layer and the support. As a result, a problem arises in that the image areas exert insufficient strength, leading to poor printing durability.

### SUMMARY OF THE INVENTION

The present invention has been made to solve the above-described problems of the related art. It is therefore an object of the invention to provide an image forming method on a planographic printing plate precursor for plate-making in which an image is exposed to light by scanning with an infrared beam and which obviates development using any developing liquid, as well as an image exposure apparatus suitably used in the image forming method.

The present inventors have conducted intensive research and found that the aforementioned object can be achieved by, prior to image-wise exposing to light the planographic printing plate precursor having an image recording layer that contains specific microcapsules, carrying out local pre-heating at a specific region including an exposure area in the image recording layer of the planographic printing plate precursor. The invention has been made based on this finding.

The present inventors have also found that the above-described problems can be solved and the aforementioned object can be achieved by carrying out pre-heating of the entire planographic printing plate precursor having a recording layer that contains specific microcapsules, before the plate is image-wise exposed to light. The invention has been accomplished, based on this finding to solve the aforementioned problems.

A first aspect of the invention provides an image forming method on a planographic printing plate precursor including a support having disposed thereon an image recording layer that contains polymerizable compound-encapsulating microcapsules, a polymerization initiator, and a light-to-heat conversing agent, which method comprises the steps of: irradiating the planographic printing plate precursor with an infrared beam to form an image in the recording layer of the planographic printing plate precursor; and prior to irradiating an area with the infrared beam, carrying out pre-heating at a pre-heat region including the irradiation area in the image recording layer to locally bring to a pre-heat temperature, wherein the pre-heating step has been completed before the infrared beam irradiation is started.

It is preferable that the step of pre-heating at the pre-heat region to bring to the pre-heat temperature is completed between one minute prior to the infrared beam irradiation and commencement of irradiation, and more preferably the step is completed between 30 seconds prior to the infrared beam irradiation and commencement of irradication.

From the viewpoint of exerting effects and preventing stains in the non-image portion, the pre-heat temperature is preferably a temperature at which the initiator is decomposed or at which decomposition of the initiator can be facilitated effectively, and it is lower than a disintegrating (decomposing) temperature of the microcapsules. More specifically, the pre-heat temperature is preferably in the range of 50° C. to 230° C., and more preferably in the range of 50° C. to 200° C.

A second aspect of the invention provides an image exposure apparatus used in the image forming method according to the first aspect, which comprises a holding member that holds an attachable planographic printing plate precursor to the apparatus, an irradiating unit that irradiates the held planographic printing plate precursor with an infrared beam to form an image in the image recording layer of the held planographic printing plate precursor, and a pre-heating unit that locally heats a pre-heat region including an irradiation area of the planographic printing plate precursor to bring to a pre-heat temperature before performing infrared beam irradiation.

A third aspect of the invention provides an image forming method on a planographic printing plate precursor including a support having disposed thereon an image recording layer that contains cationically polymerizable compound-encapsulating microcapsules, an acid generator, and a light-to-heat conversing agent, which method comprises the steps of: carrying out pre-heating of the planographic printing plate precursor to bring to a pre-heat temperature, and irradiating the pre-heated planographic printing plate precursor with an infrared beam to form an image in the image recording layer of the planographic printing plate precursor.

The pre-heat temperature is preferably specified within a temperature range capable of activating the acid generator present in the system and not disintegrating the microcapsule wall material. The pre-heat temperature is generally in the range of 50° C. to 230° C., and more preferably in the range of 50° C. to 200° C.

A fourth aspect of the invention provides an image exposure apparatus used in the image forming method according to the third aspect, which comprises a holding member that holds an attachable planographic printing plate precursor to the apparatus, a pre-heating unit that heats the held planographic printing plate precursor to bring to a pre-heat temperature by applying thermal or electromagnetic energy from a linearly extending or two-dimensionally spreading heat supplying unit, and an irradiating unit that irradiates the held planographic printing plate precursor with an infrared beam to form an image in the image recording layer of the planographic printing plate precursor.

In the first and the second aspects of the invention, the planographic printing plate precursor has the recording layer that contains polymerizable compound-encapsulating microcapsules, a polymerization initiator, and a light-to-heat conversing agent. In the third and the fourth aspects of the invention, the planographic printing plate precursor has the recording layer that contains cationically polymerizable compound-encapsulating microcapsules, an acid generator, and a light-to-heat conversing agent.

In the aforementioned planographic printing plate precursors, images can be formed by the following mechanism. The energy of the infrared beam for image-wise exposure is converted into thermal energy by the light-to-heat conversing agent. The microcapsule wall is disintegrated or acquires permeability by the generated heat, whereby the encapsulated polymerizable compound is released (allowed to exude) outside the microcapsules. Alternatively, a reaction-initiating substance generated from the polymerization initiator by the energy for image-wise exposure acts as the polymerization initiator for the polymerizable compound released (allowed to exude) outside the microcapsules, which triggers the polymerization reaction to start and proceed such that a surface hydrophobic region, namely, the image portion is formed. However, with only the energy for the image-wise exposure, it is difficult to make the microcapsule wall permeable to activate the polymerization initiator or to produce, in the image recording layer, an acid and initiating species such as a radical in such a sufficient amount (concentration) that the curing reaction of the polymerizable compound can be progressed. Additionally, thermal diffusion (heat absorption) from the recording layer to the support may occur in the vicinity of the interface between the recording layer and the support, whereby the initiating species necessary to initiate and progress the polymerization reaction cannot be supplied in a sufficient amount. Therefore, the recording layer cannot be cured sufficiently, thus failing to form images with firm and good printing durability. With only the energy for the image-wise exposure, it is insufficient to disintegrate the microcapsules and activate the acid generator. Also, as mentioned above, thermal diffusion (heat absorption) from the recording layer to the support occurs in the vicinity of the interface between the recording layer and the support, and hence unreacted microcapsules or unreacted acid generator will still remain, thus failing to form images with firm and good printing durability.

In the image forming method according to the first aspect of the invention, heat is locally applied to a specific region including the irradiation area by energy up to a temperature at which the microcapsules are not disintegrated (generally up to approximately 270° C.) before the planographic printing plate precursor is image-wise exposed to light (hereinafter appropriately referred to as “pre-heating”). The pre-heat temperature is preferably in a range of 50° C. to 230° C. By carrying out this heating, the irradiation area and the vicinity thereof are locally heated such that the atmosphere around the area acquires a higher temperature than that of the surrounding area in the image recording layer. In such a state, mobility of the reaction initiating substance or the polymerizable compound can be increased, and hence the initiation or progress of the polymerization reaction can be facilitated. The heating temperature may be set to a temperature capable of activating the polymerization initiator present in the area, for example, a temperature of approximately 140° C. to 200° C. In such a case, a sufficient amount of the reaction initiating substance can be generated from the polymerization initiator in advance, and then image-wise exposure can be performed until the polymerization initiator almost loses its activity. In this case, most of the energy for the image exposure can be used to make the microcapsule wall permeable. Therefore, the microcapsules can be disintegrated efficiently, and the polymerizable compound released (exuding) from the irradiation area can immediately and efficiently start the polymerization reaction with a sufficient amount of the reaction initiating substance, which is generated by pre-heating under preferred conditions. Thus, both actions can synergistically contribute to form images with firm and good printing durability.

The pre-heating is performed only locally in the specific region including the image-wise exposure area where irradiation is performed in a subsequent step in order to facilitate reactivity for image formation. Therefore, energy loss is minimal and the time period from pre-heating to image-wise exposure is short. As a result, image-wise exposure can be performed while the active components in the recording layer maintain high mobility, preferably until the active species generated in advance almost lose their activity, thereby leading to an efficiently increased polymerization reaction.

In the image exposure apparatus according to the second aspect of the invention, the pre-heating unit serves to heat a pre-heat region including the irradiation area on the planographic printing plate precursor to locally bring to a pre-heat temperature before the area included in the region is irradiated with an infrared beam emitted from the irradiating unit. By using this apparatus, the planographic printing plate precursor can be scanned with the infrared beam, after at least the image recording layer of the planographic printing plate precursor has been heated to the specific pre-heat temperature. As described above, therefore, most of energy for image-wise exposure is used to disintegrate the microcapsule wall. Hence the polymerizable compound entirely released (exuding) from the microcapsules can start or proceed to undergo polymerization reaction in an efficient manner with a sufficient amount of initiating species. The pre-heating unit can be effectively controlled to work together with the irradiating unit for conducting pre-heating locally at the specific region where improved reactivity for image formation is expected, thereby the supplied thermal energy can effectively contribute to enhanced reactivity.

In the image forming method according to the third aspect of the invention, at least the entire region where the image is to be formed in the recording layer of the planographic printing plate precursor is heated by thermal energy up to a temperature at which the microcapsules are not disintegrated (generally up to approximately 270° C.) before the planographic printing plate precursor is irradiated with the infrared beam for image formation (hereinafter appropriately referred to as “pre-heating”). The pre-heat temperature is preferably in the range of approximately 50° C. to 230° C. By this heating, the support of the planographic printing plate precursor has been heated beforehand, so that thermal diffusion to the support can be reduced in the subsequent image-wise exposing step. Therefore, most of energy for image-wise exposure can be efficiently used for forming images, specifically for decomposing the acid generator and disintegrating the microcapsules, when the polymerization reaction is allowed to start between the polymerizable compound released (exuding) from the microcapsules and the acid generated from the acid generator. In this step, the image recording layer is also pre-heated together with the support such that mobility of the reactive materials present in the reaction system can be enhanced by heat. Consequently, the polymerization reaction can proceed efficiently, thereby forming images with firm and good printing durability.

In a more preferred embodiment, the pre-heat temperature is set within a temperature range capable of activating the acid generator, for example, a temperature range of approximately 140° C. to 200° C. In such a case, an additional effect is obtained whereby a sufficient amount of an acid can be generated from the acid generator by pre-heating. In such a step, image-wise exposure can be performed when there is a sufficient amount of the acid acting as the initiating species. Such a sufficient amount of the acid existing around respective microcapsules, which have been made permeable by the image-wise exposure, can immediately be allowed to start and proceed with the polymerization reaction with the cationically polymerizable compound exuding from respective microcapsules. Thus, the reaction proceeds efficiently and the effects of the invention can be exerted significantly.

In the image exposure apparatus according to the fourth aspect of the invention, the pre-heating unit serves to heat the attachable planographic printing plate precursor held by the holding member to bring to a specific pre-heat temperature by thermal or electromagnetic energy supplied from the linearly extending or two-dimensionally spreading heat supplying unit. Thereafter, the irradiating unit serves to irradiate the attachable planographic printing plate precursor held by the holding member with the infrared beam such that images can be formed in the image recording layer of the planographic printing plate precursor. Using this apparatus, the image recording layer and/or the support of the planographic printing plate precursor are heated to the specific pre-heat temperature, after which infrared beam irradiation can be performed, and therefore, most of energy for image-wise exposure is used for disintegrating the microcapsules. Accordingly, the polymerization reaction can efficiently start and proceed between the polymerizable compound released wholly (exuding) from the microcapsules and a sufficient amount of the acid.

### BRIEF DESCRIPTION OF THE DRAWINGS

Preferred embodiments of the present invention will be described in detail based on the following figures, wherein:

FIG. 1 is a side view showing a structure of an image exposure apparatus relating to a first embodiment of the present invention;

FIG. 2 is a perspective view showing a structure of an exposing head and a feeding system equipped in the image exposure apparatus shown in FIG. 1;

FIG. 3 is a side view showing a structure of an image exposure apparatus relating to a second embodiment of the invention;

FIG. 4 is a perspective view showing a structure of an exposing head and a feeding system equipped in the image exposure apparatus shown in FIG. 3;

FIG. 5 is a perspective view showing a structure of a pre-heating unit equipped in the image exposure apparatus shown in FIG. 3;

FIG. 6 is a side view of the pre-heating unit shown in FIG. 5;

FIG. 7 is a perspective view showing a structure of a coil unit of the pre-heating unit shown in FIG. 5; and

FIG. 8 is a side view showing a structure of the image exposure apparatus relating to a third embodiment of the invention.

### DETAILED DESCRIPTION OF THE INVENTION

Structure of Image Exposure Apparatus

By reference to drawings, a detailed description will be made of an image exposure apparatus by which image forming methods according to the present invention are suitably carried out.

### First Embodiment

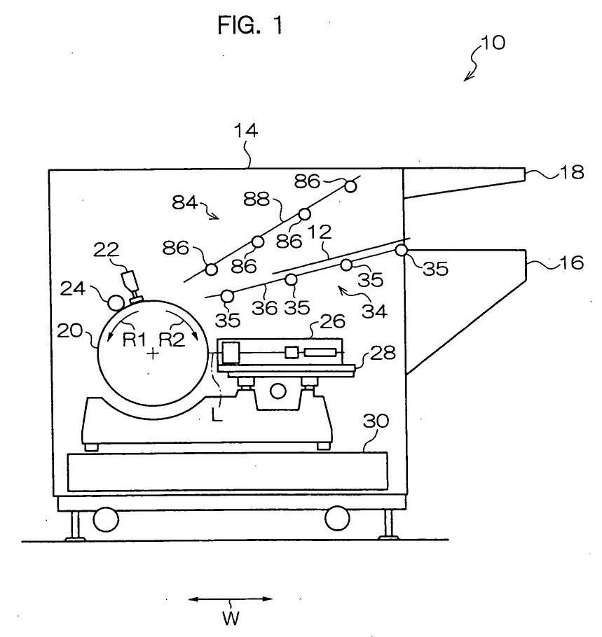

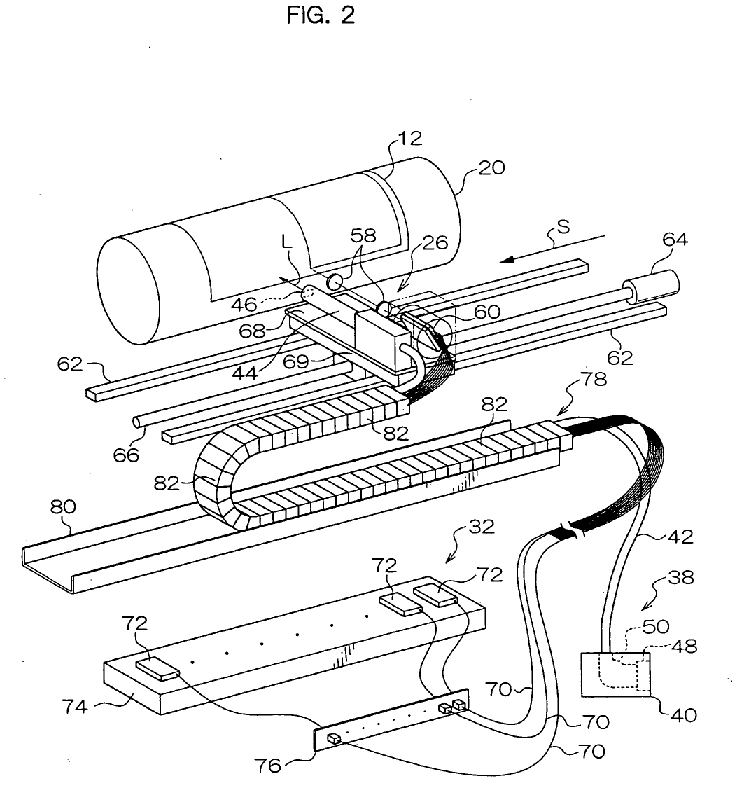

FIGS. 1 and 2 show the image exposure apparatus relating to a first embodiment of the invention. In the image exposure apparatus 10, a planographic printing plate precursor 12 is scanned with a beam of an infrared laser (hereinafter referred to as “IR laser L”) which is modulated based on digital image information, whereby an image (a latent image) corresponding to the digital image information is formed on the planographic printing plate precursor 12. The planographic printing plate precursor 12 is a so-called “process-free printing plate” which does not require any particular development process, comprising a support made of aluminum or an aluminum alloy having disposed thereon an image recording layer (hereinafter simply referred to as “recording layer”) which includes at least polymerizable compound-containing microcapsules, a polymerization initiator, and a light-to-heat conversing agent.

The polymerization initiator such as the acid generator and a radical generating agent and the light-to-heat conversing agent may each be contained in at least either inside the microcapsules or outside the microcapsules, namely, in a matrix of the recording layer. From the viewpoint of storability, the polymerization initiator is preferably contained in the matrix of the recording layer. From the viewpoint of sensitivity, the light-to-heat conversing agent is preferably contained in the microcapsules.

As shown in FIG. 1, the image exposure apparatus 10 includes a casing 14 to serve as an outer shell of the apparatus. A plate supplying platform 16 for providing a stack of the planographic printing plate precursors 12 is attached to the casing 14 at a side plate portion on one side in the width direction (indicated by an arrow W) of the apparatus. Above the plate supplying platform 16, a discharging tray 18 is also provided for discharging the planographic printing plate precursor 12 after being subjected to light exposure. Inside the casing 14, a cylinder-shaped outer drum 20 is rotatably placed, on which one sheet of the planographic printing plate precursor 12 can attachably and detachably be placed. Outward the periphery of the outer drum 20, a chucking system 22 is provided for chucking front and rear ends of the planographic printing plate precursor 12, and a guide roller 24 is placed for winding the planographic printing plate precursor 12 on the peripheral surface of the outer drum 20.

Inside the casing 14, an exposing head 26 is placed to face the outer drum 20, and a feeding system 28 is provided to support the exposing head 26 so that the head 26 can move along the sub-scanning direction. By means of the exposing head 26 and the feeding system 28, the planographic printing plate precursor 12 placed on the outer drum 20 is scanned with an IR laser L beam modulated based on the digital image information, whereby an image corresponding to the digital image information is formed in the recording layer of the planographic printing plate precursor 12. In the casing 14, a light source box 30 is also placed under the outer drum 20. In the light source box 30, an LD light source unit 32 (see FIG. 2) is provided for feeding the IR laser L beam to the exposing head 26.

As shown in FIG. 1, in the image exposure apparatus 10, a supplying system 34 is housed for feeding one of the planographic printing plate precursors 12 stacked on the plate supplying platform 16 to the outer drum 20 in the casing 14. The supplying system 34 comprises plural conveying rollers 35 arranged along a transport route for the planographic printing plate precursors 12 and a plate-shaped guide member 36. In the supplying system 34, a separating system (not shown) is also provided on the end side of the plate supplying platform 16. The separating system acts to separate one plate from a pile of the planographic printing plate precursors 12 stacked on the plate supplying platform 16 to render one plate 12 conveyed to the transport route.

In the image exposure apparatus 10, the planographic printing plate precursor 12 is conveyed to the vicinity of top of the outer drum 20 by means of the supplying system 34. The front end of the planographic printing plate precursor 12 is then chucked on the outer drum 20 by the chucking system 22, and the outer drum 20 starts rotating in a given normal direction (indicated by an arrow R1 in FIG. 1). The planographic printing plate precursor 12, whose front end is restrained on the outer drum 20 by a front end clamp, is forced forward and wound around the peripheral surface of the outer drum 20 by means of the guide roller 24.

When the planographic printing plate precursor 12 as a whole including its rear end is wound around the outer drum 20 in the image exposure apparatus 10, the rear end of the plate 12 is chucked onto the outer drum 20 by the chucking system 22. Thus, the entire planographic printing plate precursor 12 is brought into close contact with the peripheral surface of the outer drum 20, and attachment of the plate 12 onto the outer drum 20 is completed. In the image exposure apparatus 10, the exposing head 26 is then allowed to move in the sub-scanning direction by the feeding system 28, while the IR laser L beam is emitted from the exposing head 26 and then guided to the planographic printing plate precursor 12 placed on the outer drum 20, whereby the plate 12 is sub-scanned with the laser beam. In the image exposure apparatus 10, the outer drum 20 is also allowed to rotate in the normal direction in a certain rotational amount corresponding to the main scanning pitch, in synchronization with completion of one sub-scanning, and consequently the main scanning can be conducted on the planographic printing plate precursor 12.

As shown in FIG. 2, the exposing head 26 is equipped with: a lens unit 58 comprising plural lenses to constitute an image-focusing optical system; a pair of support plates that hold the front end of plural optical fibers 70; and a fiber holder 60 comprising a transparent protection plate that protects the tip end of the optical fibers 70, and the like. The exposing head 26 is mounted on a plate-shaped carrier 68 to allow movement in the sub-scanning direction (indicated by an arrow S in FIG. 2) together with the carrier 68. The IR laser L beams emitted from the optical fibers 70 are made incident to the lens unit 58 and converged by the lens unit 58 to form a beam spot with a specific shape and size and thereby produce an image on the planographic printing plate precursor 12 attached to the outer drum 20.

The feeding system 28 also comprises: a pair of guide rails 62 that support the carrier 68 such that the carrier 68 can slide in the sub-scanning direction; and a screw shaft 66 connected to a motor unit 64. A block-shaped female screw member 69 is fixed to the bottom face of the carrier 68, and the screw shaft 66 has been pushed in the screw hole of the female screw member 69. Thus, as the screw shaft 66 is rotated by the motor unit 64, the exposing head 26 moves together with the carrier 68 in the sub-scanning direction (in a forward or a backward direction) corresponding to the rotational direction of the screw shaft 66 in a certain distance corresponding to the rotational amount of the screw shaft 66. In the image exposure apparatus 10 relating to this embodiment, sub-scanning of the planographic printing plate precursor 12 is performed only when the exposing head 26 moves in the forward direction.

As shown in FIG. 2, the other end of the optical fibers 70 is connected to plural semiconductor lasers 72, respectively, in the LD light source unit 32. The semiconductor lasers 72 are fixed on a plate-shaped heat sink 74 in the LD light source unit 32. At intermediate points on the respective optical fibers 70, a connector array 76 is provided, through which the fiber holder 60 side portion of each optical fiber 70 is detachably connected to the semiconductor laser 72 side portion of each optical fiber 70. Thus, even if any of the LD semiconductor lasers 72 is out of order, the non-performing semiconductor laser 72 can be easily replaced with a new one without disassembling the fiber holder 60 and the like.

In the feeding system 28, a tube-shaped cable bearer 78 and a gutter-shaped bearer guide 80 are placed under the guide rail 62 to permit extension in the sub-scanning direction. The cable bearer 78 is divided into numbers of connected link pieces 82 along the longitudinal direction. The link pieces 82 are serially connected to form a flexible structure to allow flexibility in the upward and downward directions. The exposing head 26 side portion (tip portion) of each optical fiber 70 is inserted into the cable bearer 78. The bearer guide 80 supports the cable bearer 78 from the lower side and limits the forward or backward shift of the cable bearer 78. In such a structure, the cable bearer 78 protects the front side portion of each optical fiber 70, which moves together with the exposing head 26, whereby each optical fiber 70 can be prevented from being damaged in case where the exposing head 26 moves in the sub-scanning direction.

The image exposure apparatus 10 includes a pre-heating unit 38 placed in the casing 14. The pre-heating unit 38 is provided for heating the planographic printing plate precursor 12 by blowing a hot blast. As shown in FIG. 2, the pre-heating unit 38 includes a heating fan unit 40 and a tube-shaped hot blast nozzle 44 connected to the heating fan unit 40 through a flexible duct 42. The heating fan unit 40 is fixed to the casing 14, and the hot blast nozzle 44 is mounted on the carrier 68 together with the exposing head 26. The front portion of the flexible duct 42 is also inserted into the cable bearer 78 together with a bundle of the optical fibers 70.

In such a structure, the hot blast nozzle 44 on the carrier 68 is placed adjacent to and downstream from the exposing head 26 along the sub-scanning direction. The hot blast nozzle 44 has a blow outlet 46 with a specific opening shape at its front end, and the opening of the blow outlet 46 faces the peripheral surface of the outer drum 20.

The heating fan unit 40 is equipped with: a heating section 48 for heating air breathed from outside the casing 14, such as a halogen heater and a ceramic heater; and a blowing section 50 through which the heated air is driven into the flexible duct 42 under pressure. The air having a high temperature is supplied through the flexible duct 42 to the hot blast nozzle 44 and blown as hot air from the blow outlet 46 of the nozzle 44 onto the planographic printing plate precursor 12 placed on the outer drum 20. The hot blast nozzle 44 adjacent to the exposing head 26 is placed downstream of the exposing head 26 in the sub-scanning direction. Therefore, the hot air is driven from the outlet 46 of the nozzle 44 onto a certain region (hereinafter referred to as “a pre-heat region” as appropriate) located adjacent to and (in the sub-scanning direction) downstream from an irradiated portion to have the spot of the beam emitted from the IR laser L (hereinafter referred to as “an irradiation area” as appropriate) in the planographic printing plate precursor 12. At the pre-heat region, the recording layer is heated up to the specific pre-heat temperature.

The pre-heat region has a sufficiently larger size than that of the beam spot (the irradiation area) along the sub-scanning and main scanning directions. As such, the pre-heat region in the planographic printing plate precursor 12 is heated up to the pre-heat temperature, and then a certain area included in the pre-heat region is immediately subjected to light exposure at the beam spot formed by means of the exposing head 26. The image exposure apparatus 10 also includes a heat control section (not shown) for controlling the pre-heating unit 38. The heat control section controls the temperature and quantity of the hot air supplied from the heating fan unit 40 to the hot blast nozzle 44 such that the temperature of the pre-heat region of the planographic printing plate precursor 12 can be adjusted properly to the specific pre-heat temperature.

A temperature sensor such as an infrared radiometer may be provided on the carrier 68 to determine the temperature of the pre-heat region (surface temperature) and output, to the heat control section, the measurement signal corresponding to the surface temperature of the pre-heat region. As such, the heat control section can control the temperature of the pre-heat region in a feedback manner based on the measurement signal, whereby the temperature of the pre-heat region can be adjusted precisely to the specific pre-heat temperature.

As shown in FIG. 1, in the casing 14 of the image exposure apparatus 10, a discharging system 84 is provided for feeding, to the discharging tray 18, the planographic printing plate precursor 12 to be detached from the outer drum 20. The discharging system 84 comprises plural conveying rollers 86 arranged along the transport route for the planographic printing plate precursor 12 and a plate-shaped guide member 88.

After image-wise exposure of the planographic printing plate precursor 12 placed on the outer drum 20 (image formation) is completed in the image exposure apparatus 10, the outer drum 20 is allowed to rotate in a reverse direction (indicated by an arrow R2 in FIG. 1), and the rear end of the plate 12 and the front end thereof are separated from the outer drum 20 by means of the chucking system 22. In synchronization with this operation, the discharging system 84 rotates the conveying rollers 86, so that the planographic printing plate precursor 12, which is transferred from the outer drum 20 to the entry port of the transport route, is started to be delivered to the discharging tray 18. In this way, the planographic printing plate 12 is discharged to the discharging tray 18.

Concerning the time point of pre-heating, heating to bring to the specific pre-heating temperature is preferably completed between one minute prior to the infrared beam irradiation for image-wise exposure and commencement of irradiation, more preferably between 30 seconds prior to the infrared beam irradiation for image-wise exposure and commencement of irradiation. Such a period may be selected appropriately depending on the available exposure apparatus, the heating unit, the active components in the planographic printing plate precursor, or the desired sensitivity. The time point of pre-heating can be controlled by modifying a perimeter of the drum in the exposure apparatus, a main scanning speed, a distance between the exposing head and the pre-heating head, or the like.

In the image exposure apparatus 10 according to the invention, the pre-heating unit 38 pre-heats the pre-heat region in the planographic printing plate precursor 12 by blowing hot air directly on the surface of the plate 12. Examples of the pre-heating unit include not only the hot air type but also a heater type comprising a heater element mounted on the carrier 68, such as a halogen heater and a ceramic heater, from which infrared light is emitted to the planographic printing plate precursor 12 to heat the pre-heat region; a magnetron type comprising a magnetron mounted on the carrier 68, from which an electromagnetic wave with a specific wavelength is emitted to the image recording layer of the planographic printing plate precursor 12 to heat (electromagnetically heat) such a material as water present in the image recording layer by resonance; and a magnetic coil type comprising a magnetic coil mounted on the carrier 68, from which high-frequency magnetic field is applied to a metallic support of the planographic printing plate precursor 12 to inductively heat the support.

If the electromagnetic wave heating is employed, the components of the recording layer should preferably include a component that can be heated by resonance with the electromagnetic wave, so that the electromagnetic wave can effectively be absorbed and converted into thermal energy. If a general electromagnetic wave with a frequency of 240 Hz is used, water can serve as such a component. Therefore, if a water-retaining compound such as a hydrophilic resin and a water-soluble compound is included in the components of the recording layer, the water retention characteristics of the recording layer can be improved, and heat can efficiently be generated. Examples of the hydrophilic resin include those described in a section of the hydrophilic resin section below. From the viewpoint of improving the water retention characteristics of the recording layer, particularly preferred examples thereof include polysaccharides such as gum arabic, soya gum, hydroxypropylcellulose, and hydroxymethylcellulose; a polymer compound possessing a hydroxyl group in its molecule, such as polyacrylic acid, sodium polyacrylate, poly(hydroxypropyl acrylate), and polyvinyl alcohol; and such a low molecular weight compound as a polyhydric alcohol including sorbitol, glycerol and the like.

Thereafter, the planographic printing plate precursor subjected to the image exposure and output from the image exposure apparatus may be placed into a printing machine without undergoing any particular development process using a liquid developer and may be subjected to printing with ink and a wetting solution according to a usual procedure. In the printing process, the unexposed portion of the planographic printing plate precursor after exposure is easily removed by the aqueous component of a wetting solution and the like or by the oil component such as ink, at an early stage, so that the hydrophilic surface of the support is exposed. The wetting solution contacts with the exposed surface, so that a non-image portion is formed, and the hydrophobic area cured by exposure forms an ink-accepting image portion.

Alternatively, the planographic printing plate precursor may be subjected to a development process using a liquid developer of water or any appropriate aqueous solution and then subjected to printing.

In the planographic printing plate precursor on which an image has been formed according to the method of the present invention, the image portion, which is sufficiently cured through the pre-heating step locally performed at high efficiency, has high strength. Therefore, high printing durability can be achieved, which otherwise could not be obtained on the so-called on-machine development type of the conventional planographic printing plate. Thus, a larger number of high quality prints can be produced.

It will be understood that the method of the invention may be applied not only to the digital data-based scanning irradiation with the infrared laser, but also to an analog data-based image exposure, insofar as the exposure process uses the infrared beam.

### Second Embodiment

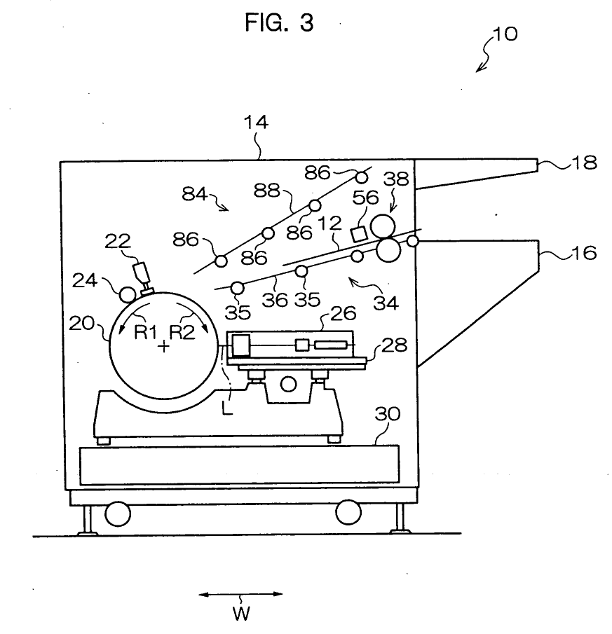

FIGS. 3 to 7 show the image exposure apparatus according to the second embodiment of the invention. In the image exposure apparatus 10, a planographic printing plate precursor 12 is scanned with and exposed to a beam of an infrared laser (hereinafter referred to as “IR laser L”) which is modulated based on digital image information, whereby an image (a latent image) corresponding to the digital image information is formed on the planographic printing plate precursor 12, which is a so-called process-free printing plate that does not require any particular development process. The planographic printing plate precursor 12 comprises a support made of aluminum or an aluminum alloy and an image recording layer (hereinafter simply referred to as “recording layer”) that is disposed on the support and at least contains cationically polymerizable compound-encapsulating microcapsules, an acid generator and a light-to-heat conversing agent.

The acid generator and the light-to-heat conversing agent may each be contained in at least either outside the microcapsules or inside the microcapsules, namely the matrix of the recording layer. From the viewpoint of storability, the acid generator is preferably contained in the matrix of the recording layer. From the viewpoint of sensitivity, the light-to-heat conversing agent is preferably contained in the microcapsules.

As shown in FIG. 3, the image exposure apparatus 10 includes a casing 14 that serves as an outer shell of the apparatus. A plate supplying platform 16 for providing a stack of planographic printing plate precursors 12 is attached to the casing 14 at a side plate portion on one side in the width direction (indicated by an arrow W) of the apparatus. Above the plate supplying platform 16 on the casing 14, a discharging tray 18 is also provided for discharging the planographic printing plate precursor 12 after being subjected to light exposure. Inside the casing 14, a cylinder-shaped outer drum 20 is rotatably placed, on which one sheet of the planographic printing plate precursor 12 can attachably and detachably be placed. Outward the periphery of the outer drum 20, a chucking system 22 is provided for chucking front and rear ends of the planographic printing plate precursor 12, and a guide roller 24 is provided for winding the planographic printing plate precursor 12 on the peripheral surface of the outer drum 20.

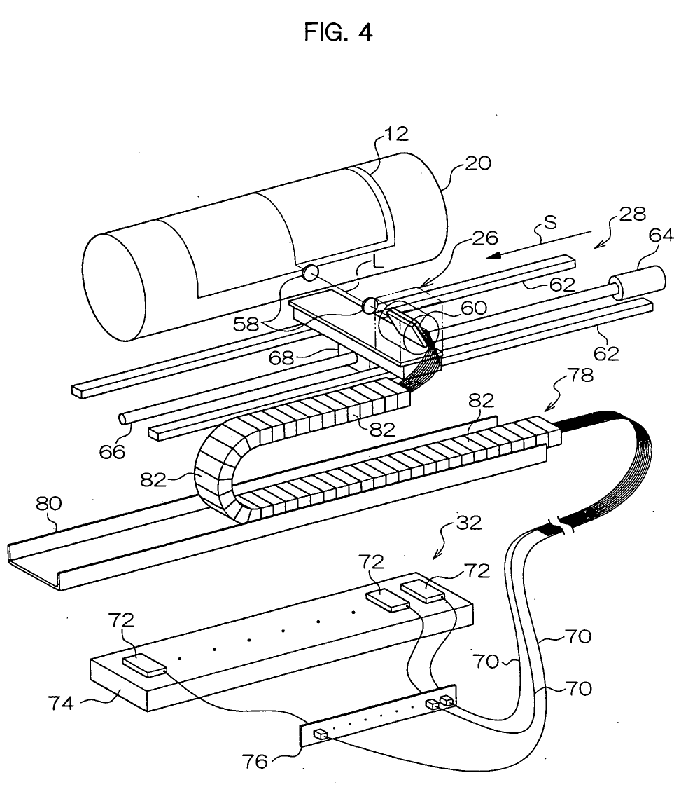

Inside the casing 14, an exposing head 26 is placed to face the outer drum 20, and a feeding system 28 is provided to support the exposing head 26 such that the head 26 can move along the sub-scanning direction. By means of the exposing head 26 and the feeding system 28, the planographic printing plate precursor 12 placed on the outer drum 20 is scanned with and exposed to an IR laser L beam modulated based on the digital image information, whereby an image corresponding to the digital image information is formed on the planographic printing plate precursor 12. In the casing 14, a light source box 30 is also placed under the outer drum 20. In the light source box 30, an LD light source unit 32 (see FIG. 4) is provided for feeding the IR laser L beam to the exposing head 26.

As shown in FIG. 3, in the image exposure apparatus 10, a supplying system 34 is provided for feeding one of the planographic printing plate precursors 12 stacked on the plate supplying platform 16 to the outer drum 20 in the casing 14. The supplying system 34 comprises plural conveying rollers 35 arranged along the transport route for the plate 12 and a plate-shaped guide member 36. In the supplying system 34, a separating system (not shown) is also provided on the end side of the plate supplying platform 16. The separating system acts to separate one plate from a batch of the planographic printing plate precursors 12 stacked on the rack 16 to render one plate 12 conveyed to the transport route. The supplying system 34 is also provided with a pre-heating unit 38 for heating (pre-heating) the entirety of the planographic printing plate precursor 12 at an intermediate point on the transport route.

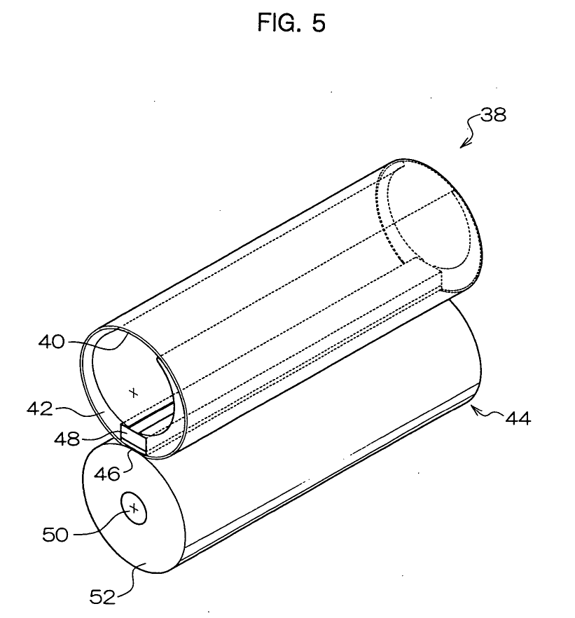

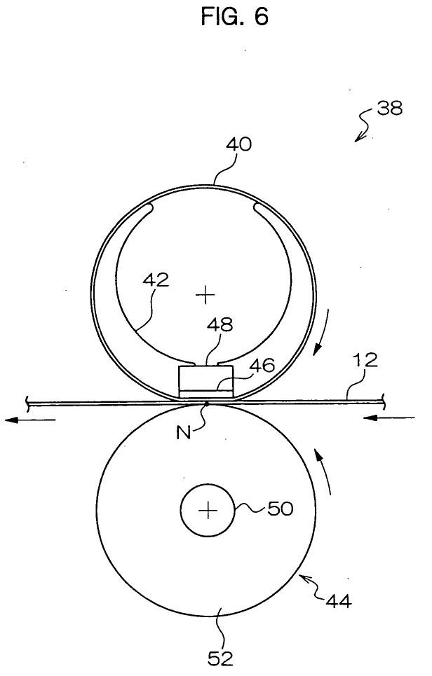

The pre-heating unit 38 heats the planographic printing plate precursor 12 by magnetic induction heating. As shown in FIGS. 5 and 6, the pre-heating unit 38 comprises a heat-resistant endless film 40, a film guide 42 placed on the inner surface of the heat-resistant film 40 and a press roller 44 placed under the heat-resistant film 40. The film guide 42 has a substantially C-shaped cross section with its opening facing upward, and its size in the axial direction is longer than the width of the planographic printing plate precursor 12. A plate-shaped heating member 46 made of magnetic metal and a coil unit 48 are placed at the bottom of the film guide 42. The coil unit 48 and the heating member 46 each have a size longer than the width of the planographic printing plate precursor 12.

The lower face of the heating member 46 forms part of the peripheral face of the film guide 42, and the upper face of the heating member 46 are tightly in contact with the coil unit 48. The inner perimeter of the heat-resistant film 40 has a slight margin relative to the outer perimeter of the film guide 42, whereby the heat-resistant film 40 can be fit on the periphery of the film guide 42 in a loose state without causing a tension on the periphery side of the film guide 42.

The press roller 44 comprises a rod-shaped core 50 placed at the axial core portion and an elastic layer 52 that is fixed on the periphery of the core 50 and has a thick cylinder shape. The elastic layer 52 is made of a rubber material with good releasing property, such as silicone rubber. The press roller 44 is supported in such a manner that it can be rotated at a linear velocity identical to the conveying speed of the planographic printing plate precursor 12 by a torque from a drive motor (not shown) connected to the core 50 and that it can press the heating member 46 via the heat-resistant film 40. A press portion N (see FIG. 6) provided between the press roller 44 and the heating member 46 is located on the transport route for the planographic printing plate precursor 12. The planographic printing plate precursor 12, on its way from the plate supplying platform 16 to the outer drum 20, is conveyed and allowed to pass through the press portion N while pressed and sandwiched in such a structure, and the plate 12 is heated (pre-heated) at the press portion N by the pre-heating unit 38. At that time, the heat-resistant film 40 is allowed to move in a rotary manner along the peripheral surface of the film guide 42 by a frictional force generated by the planographic printing plate precursor 12.

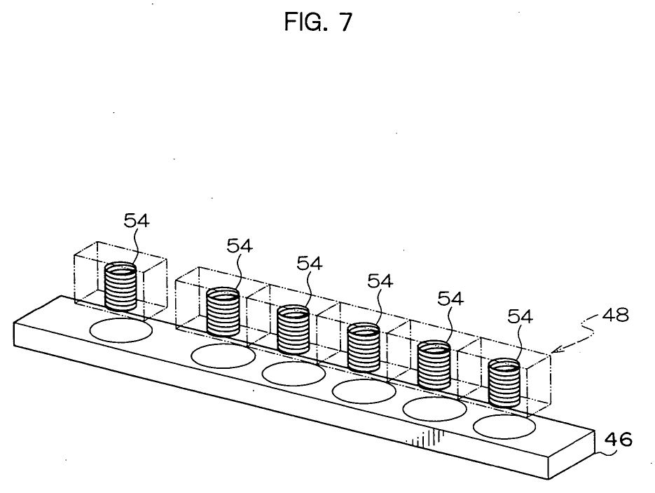

As shown in FIG. 7, the coil unit 48 comprises plural exciting coils 54 linearly arranged in the width direction of the planographic printing plate precursor 12 and connected in series. The exciting coils 54 at both ends are each connected to a high-frequency current output terminal of a high-frequency converter (not shown). When a high-frequency current is output from the high-frequency converter and applied to the exciting coils 54, a high-frequency magnetic field is generated by each exciting coil 54 and acts on the heating member 46. In such a structure, the heating member 46 made of magnetic metal is inductively heated to produce a certain amount of heat depending on the strength of the high-frequency magnetic field, the frequency of the high-frequency current, and the like. Therefore, the amount of heat to be applied from the heating member 46 to the planographic printing plate precursor 12 can be controlled by changing the waveform (a switching duty, frequency, or the like) of the high-frequency current applied from the high-frequency converter to the exciting coils 54 and controlling the power supply.

As shown in FIG. 3, the image exposure apparatus 10 includes a temperature sensor 56 provided immediately behind the pre-heating unit 38 along the transport route. The temperature sensor 56 detects the surface temperature of the planographic printing plate precursor 12 passing through the pre-heating unit 38 and outputs the detection signal to the heat control section (not shown) of the unit 38. The heat control section controls the high-frequency converter in a feedback manner based on the detection signal sent from the temperature sensor 56, whereby the planographic printing plate precursor 12 passing through the press portion N is heated to a predetermined pre-heating temperature. In the pre-heating unit 38, the lower part of the heating member 46 has a flat face, such that the heating member 46 can be pressed to and brought into face-contact with the planographic printing plate precursor 12 passing through the press portion N. Alternatively, the lower part of the heating member 46 may have a curved shape such that it can be pressed to and brought into line-contact with the planographic printing plate precursor 12.

In the image exposure apparatus 10, the planographic printing plate precursor 12 is conveyed to the vicinity of the top of the outer drum 20 by means of the supplying system 34. The front end of the planographic printing plate precursor 12 is then chucked on the outer drum 20 by the chucking system 22, and the outer drum 20 starts to rotate in a given normal direction (indicated by an arrow R1 in FIG. 3). The planographic printing plate precursor 12, whose front end is restrained on the outer drum 20 by a front end clamp, is then pressed and wound on the peripheral surface of the outer drum 20 by means of the guide roller 24.

When the planographic printing plate precursor 12 as a whole including its rear end is wound around the outer drum 20, the rear end of the plate 12 is chucked onto the outer drum 20 planographic printing plate precursor by the chucking system 22. Thus, the entire planographic printing plate precursor 12 is brought into contact with the peripheral surface of the outer drum 20, and the attachment of the plate 12 on the outer drum 20 is completed. In the image exposure apparatus 10, the exposing head 26 is then allowed to move in the sub-scanning direction by the feeding system 28, while the IR laser L beam is emitted from the exposing head 26 and then guided to the planographic printing plate precursor 12 placed on the outer drum 20, whereby the plate 12 is sub-scanned with the laser beam. In the image exposure apparatus 10, the outer drum 20 is also allowed to rotate in the normal direction in a certain rotation amount corresponding to the main scanning pitch, in synchronization with the completion of one sub-scanning, and consequently the main scanning can be performed on the planographic printing plate precursor 12.

As shown in FIG. 4, the exposing head 26 is equipped with: a lens unit 58 comprising plural lenses to constitute an image-forming optical system; and a fiber holder 60 comprising: a pair of support plates that hold the front ends of optical fibers 70 therebetween, a transparent protection plate that protects the front faces of the optical fibers 70, and the like. The IR laser L beams emitted from the optical fibers 70 are made incident to the lens unit 58 and converged by the lens unit 58 to form a beam spot with specific shape and size, thereby form an image on the planographic printing plate precursor 12 attached on the outer drum 20.

The feeding system 28 also comprises: a pair of guide rails 62 that support the exposing head 26 such that the head 26 can slide in the sub-scanning direction (indicated by an arrow S in FIG. 4); and a screw shaft 66 connected to a motor unit 64. A block-shaped carrier 68 is fixed to the bottom face of the exposing head 26, and the screw shaft 66 has been pushed into the screw hole of the carrier 68. Thus, as the screw shaft 66 is rotated by the motor unit 64, the exposing head 26 moves in the sub-scanning direction (in a forward or a backward direction) corresponding to the rotation direction of the screw shaft 66 in a certain distance corresponding to the amount of the rotation of the screw shaft 66. In the image exposure apparatus 10 relating to this embodiment, the sub-scanning of the planographic printing plate precursor 12 is performed only when the exposing head 26 moves in the forward direction. Alternatively, the sub-scanning may be performed when the exposing head 26 moves in each of the forward and backward directions (reciprocating scanning).

As shown in FIG. 4, the other end of the optical fibers 70 is connected to plural semiconductor lasers 72, respectively, in the LD light source unit 32. The semiconductor lasers 72 are fixed on a plate-shaped heat sink 74 in the LD light source unit 32. At intermediate points on the respective optical fibers 70, a connector array 76 is provided, through which the fiber holder 60 side portion of each optical fiber 70 is detachably connected to the semiconductor laser 72 side portion of each optical fiber 70. Thus, if any of the LD semiconductor lasers 72 is out of order, the out-of-order semiconductor laser 72 can easily be replaced with a new one without disassembling the fiber holder 60 and the like.

In the feeding system 28, a tube-shaped cable bearer 78 and a gutter-shaped bearer guide 80 are placed under the guide rail 62 to permit extension in the sub-scanning direction. The cable bearer 78 is divided into numbers of connected link pieces 82 along the longitudinal direction. The link pieces 82 are serially connected to form a flexible structure to allow flexibility in the upward and downward directions perpendicular to the sub-scanning direction. The exposing head 26 side portion (front side portion) of each optical fiber 70 is inserted into the cable bearer 78. The bearer guide 80 supports the cable bearer 78 from the lower side and limits the forward or backward shift of the cable bearer 78. In such a structure, the cable bearer 78 protects the frond side portion of each optical fiber 70, which moves together with the exposing head 26, whereby each optical fiber 70 can be prevented from being damaged in case where the exposing head 26 moves in the sub-scanning direction.

As shown in FIG. 3, in the casing 14 of the image exposure apparatus 10, a discharging system 84 is provided for feeding, to the discharging tray 18, the planographic printing plate precursor 12 detached from the outer drum 20. The discharging system 84 comprises plural conveying rollers 86 arranged along the transport route for the plate 12 and a plate-shaped guide member 88.

After image-wise exposure of the planographic printing plate precursor 12 placed on the outer drum 20 to light (image formation) is completed in the image exposure apparatus 10, the outer drum 20 is allowed to rotate in a reverse direction (indicated by an arrow R2), and the rear end of the plate 12 and then the front end of it are separated from the outer drum 20 by means of the chucking system 22. In synchronization with this operation, the discharging system 84 rotates the conveying rollers 86, so that the planographic printing plate precursor 12, which is transferred from the outer drum 20 to the entry port of the transportation route, is started to be delivered to the discharging tray 18. In this way, the planographic printing plate 12 is discharged to the discharging tray 18.

### Third Embodiment

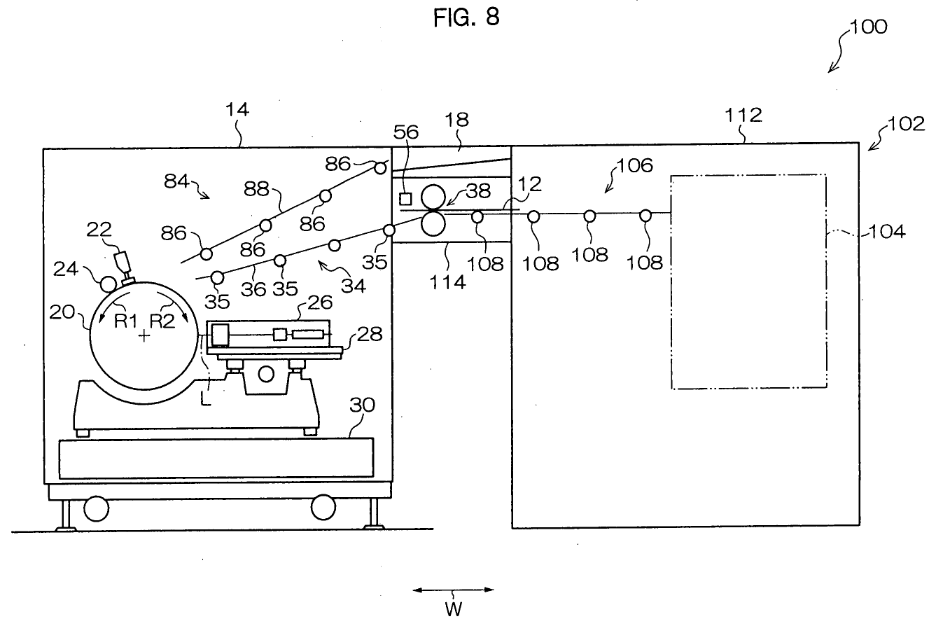

FIG. 8 shows the image exposure apparatus according to the third embodiment of the invention. In the image exposure apparatus 100 according to the third embodiment, the same elements as those of the apparatus 10 used in the second embodiment are each denoted by the same reference numeral, so as to omit the description thereof.

In the image exposure apparatus 100, the planographic printing plate precursor 12 is scanned with the IR laser L beam modulated based on digital image information, similarly in the apparatus 10 according to the second embodiment, whereby an image corresponding to the digital image information is formed on the plate 12. As shown in FIG. 8, the image exposure apparatus 100 differs from the apparatus 10 only in points: that the plate supplying platform 16 is omitted, on which the stacked planographic printing plate precursors 12 would otherwise be loaded; that an autoloader 102 is added as an optional unit in place of the plate supplying platform 16; and that the pre-heating unit is shifted to inside the autoloader 102 from inside the casing 14.

The autoloader 102 acts to supply the planographic printing plate precursor 12 to the supplying system 34 via a control section (not shown) of the image exposure apparatus 100 or based on a predetermined supplying schedule. The autoloader 102 comprises a loading section 104 to which numbers of the planographic printing plate precursors 12 can be loaded, a separating system (not shown) for separating one plate from the stacked planographic printing plate precursors 12 loaded in the loading section 104, and a conveying system 106 for feeding the one separated plate 12 along a predetermined transportation route to the supplying system 34 in the main part of the image exposure apparatus 100.

The conveying system 106 comprises feeding rollers 108 arranged along the transportation route, a guide member 110, and the like. The conveying system 106 acts to convey the planographic printing plate precursor 12 at a specific speed from the loading section 104 to the entry port of the transport route in the main part of the image exposure apparatus 100. The autoloader 102 also includes a casing 112 as an outer shell and a bridge-shaped connecting section 114 to which the casing 14 of the main part of the image exposure apparatus 100 is connected. In the autoloader 102, the planographic printing plate precursor 12 is transported by the conveying system 106 through the connecting section 114 to the casing 14 of the main part of the image exposure apparatus 100.

In the connecting section 114 of the autoloader 102, a pre-heating unit 38 is provided for pre-heating the planographic printing plate precursor 12. The pre-heating unit 38 serves to heat the planographic printing plate precursor 12 to a specific pre-heating temperature when the plate 12 is fed to the supplying system 34 by the conveying system 106. The pre-heating unit 38 according to the third embodiment basically has the same structure as that used in the second embodiment. However, the image exposure apparatus 100 has a relatively long distance from the pre-heating unit 38 to the outer drum 20, and therefore, can provide a relatively long conveying time. In some cases, therefore, the pre-heating temperature in the image exposure apparatus 100 should be higher than that is employed in the image exposure apparatus 10. Therefore, the calorific value of the pre-heating unit 38 may vary depending on how high the pre-heating temperature is.

In the image exposure apparatus 100 having such a structure according to the third embodiment, the pre-heating unit 38 is placed in the autoloader 102 as an optional unit. Therefore, the main part of the image exposure apparatus 100 has the same structure as that of a conventional image exposure apparatus not including the pre-heating unit 38. The image exposure apparatus 100, in which the pre-heating can be performed, can be devised simply by adding the autoloader 102 to a conventional image exposure apparatus as the main part. Therefore, costs and time for developing the image exposure apparatus capable of pre-heating can significantly be reduced. In addition, any commercially available image exposure apparatus can be modified into the pre-heating type apparatus only by adding the autoloader 102 and modifying a simple portion of the settings.

In the pre-heating unit 38 of the inventive image exposure apparatus 10 or 100, the heating member 46 is heated to an elevated temperature by magnetic induction, and the planographic printing plate precursor 12 is heated (indirectly) by heat transmission from the heating member 46. Alternatively, the support (an aluminum plate) of the planographic printing plate precursor 12 may be inductively heated (directly) by applying high-frequency magnetic field from the coil unit 48 to the support, without using the heating member 46.

Applicable examples of the pre-heating unit 38 include not only the magnetic induction-heating type, but also a hot blast type that heats the planographic printing plate precursor 12 by blowing hot air (hot blast) onto the plate 12 by means of a heater such as a halogen heater and a ceramic heater; a magnetron type that generates an electromagnetic wave with a specific wavelength and applies it to the image recording layer of the planographic printing plate precursor 12 so that such a material as water present in the image recording layer is heated by resonance (electromagnetically); and an infrared lamp type that applies infrared radiation from an infrared lamp to the planographic printing plate precursor to heat the plate.

Composition of the Planographic Printing Plate Precursor

A description will be given of the composition of the planographic printing plate precursor suitably used in the method of the invention for forming images which obviates to employ any liquid development process.

In an embodiment of the invention, the planographic printing plate precursor comprises a support having disposed thereon an image recording layer that contains polymerizable compound-encapsulating microcapsules, a polymerization initiator and a light-to-heat conversing agent. In another embodiment of the invention, the planographic printing plate precursor comprises a support having disposed thereon an image recording layer that contains cationically polymerizable compound-encapsulating microcapsules, an acid generator and a light-to-heat conversing agent.

<Image Recording Layer>

(Polymerizable Compound-encapsulating Microcapsule)

Examples of the polymerizable compound for use in the invention include a cationically polymerizable compound and a radical-polymerizable compound.

(Cationically Polymerizable Compound)

The cationically polymerizable compound for use in the invention may be any compound having a cationically polymerizable group in its molecule and is particularly preferably a compound having a vinyloxy group or an epoxy group.

Preferred cationically polymerizable compounds having the vinyloxy group are disclosed, for example, in JP-A No. 2002-29162.

Specific examples thereof include, but are not limited to, tetramethylene glycol divinyl ether, trimethylol propane trivinyl ether, tetraethylene glycol divinyl ether, pentaerythritol divinyl ether, pentaerythritol trivinyl ether, pentaerythritol tetravinyl ether, 1,4-bis{2-(vinyloxy)ethyloxy}benzene, 1,2-bis{2-(vinyloxy)ethyloxy}benzene, 1,3-bis{2-(vinyloxy)ethyloxy}benzene, 1,3,5-tris{2-(vinyloxy)ethyloxy}benzene, 4,4′-bis{2-(vinyloxy)ethyloxy}biphenyl, 4,4′-bis{2-(vinyloxy)ethyloxy}diphenyl ether, 4,4′-bis{2-(vinyloxy)ethyloxy}diphenyl methane, 1,4-bis{2-(vinyloxy)ethyloxy}naphthalene, 2,5-bis{2-(vinyloxy)ethyloxy}furan, 2,5-bis{2-(vinyloxy)ethyloxy}thiophene, 2,5-bis{2-(vinyloxy)ethyloxy}imidazole, 2,2-bis[4-{2-(vinyloxy)ethyloxy}phenyl]propane, bis(vinyloxyethyl)ether of bisphenol A, 2,2-bis{4-(vinyloxymethyloxy)phenyl}propane, and 2,2-bis{4-(vinyloxy)phenyl}propane. Particularly preferred are 2,2-bis[4-{2-(vinyloxy)ethyloxy}phenyl]propane, bis(vinyloxyethyl)ether of bisphenol A, 2,2-bis{4-(vinyloxymethyloxy)phenyl}propane, and 2,2-bis{4-(vinyloxy)phenyl}propane.

The epoxy group-containing cationically polymerizable compound suitable for use in the invention preferably has two or more epoxy groups. Examples of such a compound include a glycidyl ether compound produced by the reaction of a polyhydric alcohol or a polyhydric phenol with epichlorohydrin, or a prepolymer thereof; and a polymer or copolymer of glycidyl acrylate or glycidyl methacrylate.

Specific examples thereof include, but are not limited to, propylene glycol diglycidyl ether, tripropylene glycol diglycidyl ether, polypropylene glycol diglycidyl ether, neopentyl glycol diglycidyl ether, trimethylolpropane triglycidyl ether, diglycidyl ether of hydrogenated bisphenol A, hydroquinone diglycidyl ether, resorcinol diglycidyl ether, diglycidyl ether of bisphenol A or an epichlorohydrin polyaddition product of bisphenol A, diglycidyl ether of bisphenol F or an epichlorohydrin polyaddition product of bisphenol F, diglycidyl ether of halogenated bisphenol A or an epichlorohydrin polyaddition product of halogenated bisphenol A, diglycidyl ether of biphenyl type bisphenol or an epichlorohydrin polyadduct of biphenyl type bisphenol, a glycidyl etherified product of a novolak resin, a methyl methacrylate/glycidyl methacrylate copolymer, and an ethyl methacrylate/glycidyl methacrylate copolymer. Particularly preferred are diglycidyl ether of bisphenol A or an epichlorohydrin polyaddition product of bisphenol A, diglycidyl ether of halogenated bisphenol A or an epichlorohydrin polyaddition product of halogenated bisphenol A, and diglycidyl ether of biphenyl type bisphenol or an epichlorohydrin polyaddition product of biphenyl type bisphenol.

Examples of the commercially available compound thereof include Epikote 1001 (with a molecular weight of about 900 and an epoxy equivalent of from 450 to 500), Epikote 1002 (with a molecular weight of about 1,600 and an epoxy equivalent of from 600 to 700), Epikote 1004 (with a molecular weight of about 1,060 and an epoxy equivalent of from 875 to 975), Epikote 1007 (with a molecular weight of about 2,900 and an epoxy equivalent of 2,000), Epikote 1009 (with a molecular weight of about 3,750 and an epoxy equivalent of 3,000), Epikote 1010 (with a molecular weight of about 5,500 and an epoxy equivalent of 4,000), Epikote 1100L (with an epoxy equivalent of 4,000), and Epikote YX31575 (with an epoxy equivalent of 1,200) each manufactured by Japan Epoxy Resins Co., Ltd.; and Sumiepoxy ESCN-195XHN, ESCN-195XL, and ESCN-195XF each manufactured by Sumitomo Chemical Co., Ltd.

(Radical-Polymerizable Compound)

The radical-polymerizable compound for use in the invention may be any compound having an ethylenically unsaturated bond in its molecule.

Examples of the functional group having the ethylenically unsaturated bond include an acryloyl group, a methacryloyl group, a vinyl group, and an allyl group. The compound having at least one, preferably two or more, functional groups is preferably used. Such a group of the compounds are known as a monomer or crosslinking agent for radical-polymerizable compounds in the industrial field. Such compounds can be used without any limitation in the invention. Examples of the chemical form of such compounds include a monomer; a prepolymer such as a dimer, a trimer and an oligomer; a polymer or copolymer; and any mixture thereof.

Preferred examples of the radical-polymerizable compound for use in the invention include the ethylenically unsaturated group-containing compounds disclosed in JP-A No. 2001-277740.

Typical examples thereof include trimethylolpropane di(meth)acrylate, trimethylolpropane tri(meth)acrylate, pentaerythritol di(meth)acrylate, pentaerythritol tri(meth)acrylate, pentaerythritol tetra(meth)acrylate, dipentaerythritol di(meth)acrylate, dipentaerythritol penta(meth)acrylate, dipentaerythritol hexa(meth)acrylate, and an adduct of trimethylolpropane diacrylate and xylylene diisocyanate.

Examples of the ethylenically unsaturated group-containing polymer or copolymer include, but are not limited to, an ally methacrylate copolymer, an ally methacrylate/methacrylic acid copolymer, an ally methacrylate/ethyl methacrylate copolymer, and an ally methacrylate/butyl methacrylate copolymer.

Particularly preferred are dipentaerythritol tetraacrylate and an ally methacrylate/methacrylic acid copolymer.

(Other Polymerizable Compounds)

In the invention, the microcapsules may contain a thermally polymerizable compound having a heat-reactive group, as shown below, other than the above polymerizable compound.

Examples of the thermally polymerizable group include an isocyanate group used for addition reaction or a blocked form thereof; an active hydrogen atom-containing functional group (such as an amino group, a hydroxyl group and a carboxyl group) for reacting with the cationically polymerizable group or the ethylenically unsaturated group; a carboxyl group used for condensation reaction; a hydroxyl group or an amino group used for reacting with the carboxyl group; acid anhydride used for ring-opening addition reaction; and an amino group or a hydroxyl group used for reacting with the acid anhydride.

Preferred examples of the isocyanate group-containing compound suitable for use in the invention include tolylene diisocyanate, diphenylmethane diisocyanate, polymethylene polyphenyl polyisocyanate, xylylene diisocyanate, naphthalene diisocyanate, cyclohexane phenylene diisocyanate, isophorone diisocyanate, hexamethylene diisocyanate, cyclohexyl diisocyanate, and an alcohol- or amine-blocked compound thereof.

Preferred examples of the amino group-containing compound suitable for use in the invention include ethylenediamine, diethylenetriamine, triethylenetetramine, hexamethylenediamine, propylenediamine, and polyethyleneimine.

Preferred examples of the hydroxyl group-containing compound suitable for use in the invention include a compound having a methylol end group, a polyhydric alcohol such as pentaerythritol, and bisphenol or polyphenol compounds.

Preferred examples of the carboxyl group-containing compound suitable for use in the invention include an aromatic polycarboxylic acid such as pyromellitic acid, trimellitic acid and phthalic acid; and an aliphatic polycarboxylic acid such as adipic acid.

Preferred examples of the acid anhydride suitable for use in the invention include pyromellitic anhydride and benzophenone tetracarboxylic anhydride.

In the image recording layer relating to the invention, the light-to-heat conversing agent and the polymerization initiator should be contained at least either inside the microcapsules or in the matrix of the recording layer. These components may be dissolved or dispersed in a solvent and then encapsulated using the same solvent. Applicable examples of the light-to-heat conversing agent or the polymerization initiator are shown below.

Any known method may be used to effect microencapsulation of the components. Examples of the method of preparing the microcapsules include, but are not limited to, a method using coacervation as disclosed in U.S. Pat. Nos. 2,800,457 and 2,800,458; an interfacial polymerization method as disclosed in U.K. Patent No. 990,443, U.S. Pat. No. 3,287,154, and Japanese Patent Application Publication (JP-B) Nos. 38-19574, 42-446 and 42-711; a method using polymer deposition as disclosed in U.S. Pat. Nos. 3,418,250 and 3,660,304; a method using an isocyanate polyol wall material as disclosed in U.S. Pat. No. 3,796,669; a method using an isocyanate wall material as disclosed in U.S. Pat. No. 3,914,511; a method using a urea/formaldehyde based or urea/formaldehyde-resorcinol based wall material as disclosed in U.S. Pat. Nos. 4,001,140, 4,087,376 and 4,089,802; a method using a wall material such as a melamine-formaldehyde resin, hydroxycellulose and the like, as disclosed in U.S. Pat. No. 4,025,445; an in situ method using monomer polymerization as disclosed in JP-B Nos. 36-9163 and 51-9079; a spray-drying method as disclosed in U.K. Patent No. 930,422 and U.S. Pat. No. 3,111,407; and an electrolytic dispersion-cooling method as disclosed in U.K. Patent Nos. 952,807 and 967,074.

The microcapsule wall material for use in the invention may preferably has characteristics that it can swell by using the coating solvent and form three-dimensional crosslinkage. From the viewpoint of such characteristics, the microcapsule wall material is preferably polyurea, polyurethane, polyester, polycarbonate, polyamide, or any mixture thereof, and particularly preferred are polyurea and polyurethane. A heat-reactive group-containing compound may also be incorporated into the microcapsule wall.

The resulting microcapsules preferably has an average particle diameter of from 0.01 to 3.0 μm, more preferably from 0.05 to 2.0 μm, and still more preferably from 0.10 to 1.0 μm. Such a range produces good resolution and stability with time.

Such a microcapsule wall material is disintegrated or acquires permeability by the action of heat, whereby the encapsulated polymerizable compound can be released to the system to cause and progress the curing reaction. If the pre-heating temperature in the pre-heating step reaches a temperature at which the capsule wall material is made permeable, an undesired curing reaction at the non-image portion may occur to thereby stain the non-image portion. Therefore, the pre-heating temperature is preferably lower than the temperature at which the capsule wall material is made permeable. The pre-heating temperature preferably has an upper limit that is lower than the temperature at which the capsule wall material is made permeable by 30° C. The temperature at which the capsule wall material is made permeable may vary with the type or thickness of the capsule wall-forming material. For example, such a temperature is about 286° C. for the capsule wall material of an adduct of trimethylolpropane and xylylene diisocyanate, and about 278° C. for the wall material of a reaction product of an adduct of trimethylolpropane and xylylene diisocyanate, Millionate MR-200 (an aromatic isocyanate manufactured by Japan Polyurethane Co., Ltd.), and tetraethylene pentamine.

Such microcapsules may be or may not agglomerate to each other by the action of heat. It is essential that the microencapsulated material can exude to the capsule surface or outside the microcapsules by the image exposure process using the infrared beam to cause a reaction with an initiating substance generated from the polymerization initiator, as described below, or that the reaction-initiating substance can penetrate the microcapsule wall to cause curing reaction. Such a polymerizable compound may also react with a hydrophilic resin or a low molecular weight compound added as an optional component to the recording layer as described below. The microcapsules may each have different functional groups capable of thermally reacting with each other and may cause a reaction with each other. It is preferred, but not essential, that the microcapsules are fused by heat and agglomerate to each other in the image forming process.

The content of the microcapsules in the recording layer is preferably 50% by mass or more, and more preferably from 70% to 98% by mass based on the solid content of the recording layer. Such a range produces high quality image with high printing durability.

Any solvent that can dissolve the material exuded from the microcapsules and allow the wall material to swell may be added to the dispersion medium of the microcapsules-containing recording layer. Such a solvent added can promote diffusion of the material from the microcapsule to the outside during the image exposure process.

Such a solvent can easily be selected from a large number of commercially available solvents, depending on the type of the microcapsule dispersion medium, the type of the microcapsule wall material, the thickness of the wall, and the type of the encapsulated material. In case of a water-dispersed microcapsule comprising a crosslinked polyurea or polyurethane wall, preferred examples of such a solvent include alcohols, ethers, acetals, esters, ketones, polyhydric alcohols, amides, amines, and fatty acids.

Specific examples thereof include, but are not limited to, methanol, ethanol, tertiary butanol, n-propanol, tetrahydrofuran, methyl lactate, ethyl lactate, methyl ethyl ketone, propylene glycol monomethyl ether, ethylene glycol diethyl ether, ethylene glycol monomethyl ether, γ-butyrolactone, N,N-dimethylformamide, and N,N-dimethylacetamide. Two or more of these solvents may be used in combination. If a solvent cannot be dissolved alone in the microcapsule dispersion medium but can be dissolved in combination with any of the above specific solvents, such a solvent may also be used.

The content of such a solvent in a coating liquid for the recording layer is generally from 5% to 95% by mass, more preferably from 10% to 900% by mass, and still more preferably from 15% to 85% by mass, depending on the combination of the materials.

(Light-to-heat Conversing Agent)

The recording layer relating to the invention should contain the light-to-heat conversing agent, which has- a function of absorbing light energy and converting it into heat. The light-to-heat conversing agent should be added at least either inside the microcapsules or to the matrix of the recording layer. In the invention, the light-to-heat conversing agent is preferably added to the inside of the microcapsules so that the infrared light energy can efficiently contribute to the image formation.

The light-to-heat conversing agent may be any substance that absorbs infrared light, particularly near infrared light (with a wavelength of 700 to 1,200 nm), including a variety of known pigments, dyes or coloring matters and fine metal particles.

For example, suitable pigments, dyes or coloring matters and fine metal particles are disclosed in JP-A Nos. 2001-301350 and 2002-137562 and Nippon Insatsu Gakkaishi (Journal of Graphic Technology Association of Japan), Vol. 38, pp. 35-40, 2001, “New Imaging Materials, 2.Near Infrared Absorbing Dyes.” If desired, these dyes or fine metal particles may be known surface-treated ones.

Specific examples of the dyes or coloring matters include cyanine dyes, polymethine dyes, azomethine dyes, squarylium dyes, pyrylium or thiopyrylium salt dyes, dithiol metal complexes, and phthalocyanine dyes, as disclosed in U.S. Pat. Nos. 4,756,993 and 4,973,572, JP-A Nos. 10-268512 and 11-235883, JP-B Nos. 05-13514 and 05-19702, and JP-A No. 2001-347765. Particularly preferred are cyanine dyes, squarylium dyes, pyrylium salt dyes, and phthalocyanine dyes.

Examples of the pigments include insoluble azo pigments, azo lake pigments, condensed azo pigments, chelate azo pigments, phthalocyanine-based pigments, anthraquinone-based pigments, perylene- or perynone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among them, carbon black is particularly preferable.

The fine metal particles are preferably made of Ag, Au, Cu, Sb, Ge, or Pb, and more preferably Ag, Au or Cu.

Particularly preferred examples of the light-to-heat conversing agent include, but are not limited to, the compounds as shown below, in which Compounds (IR-1) to (IR-11) are hydrophilic agents that may preferably be added to the matrix of the image recording layer, and Compounds (IR-21) to (IR-29) are lipophilic agents that may preferably be microencapsulated.

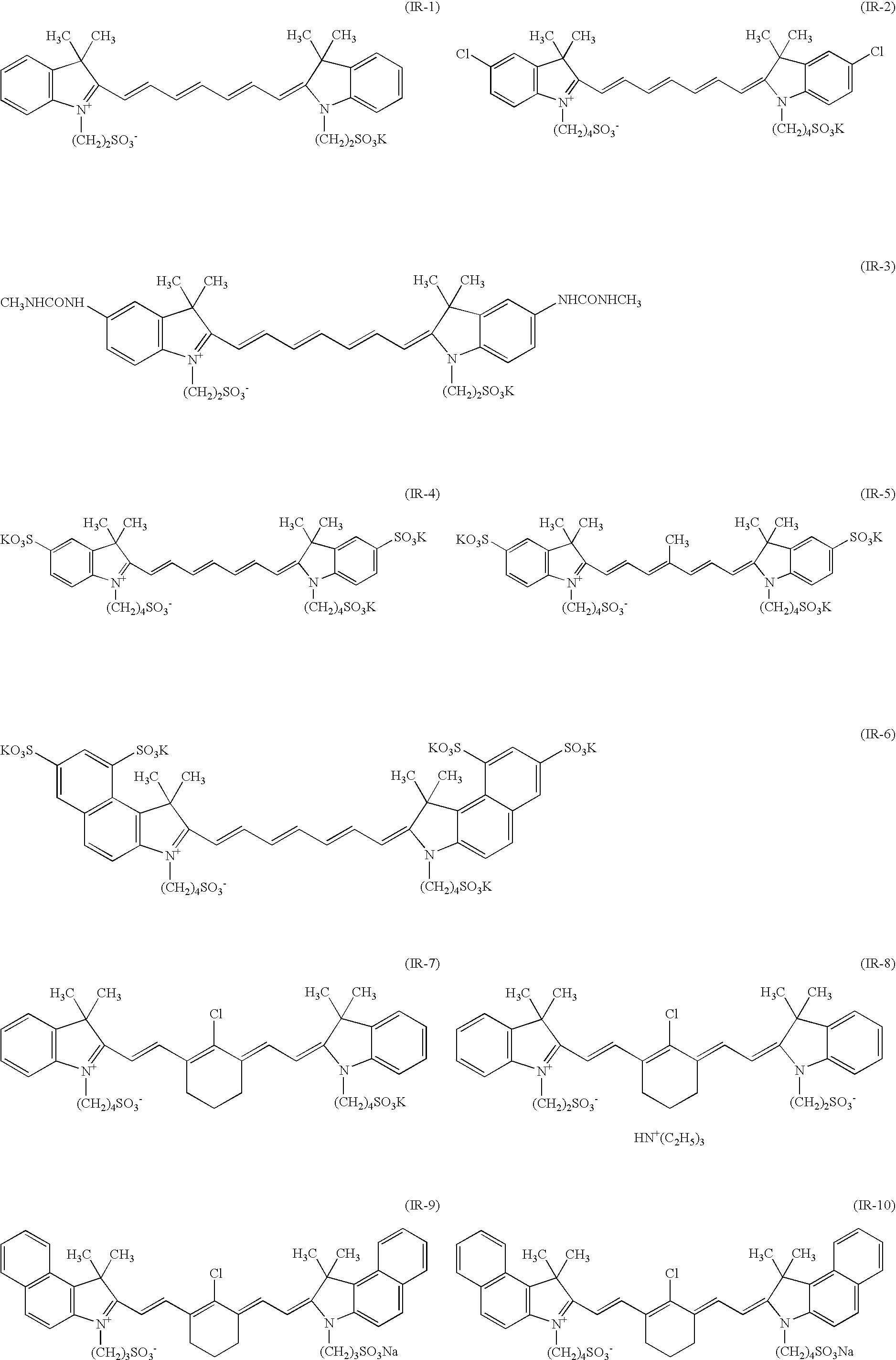

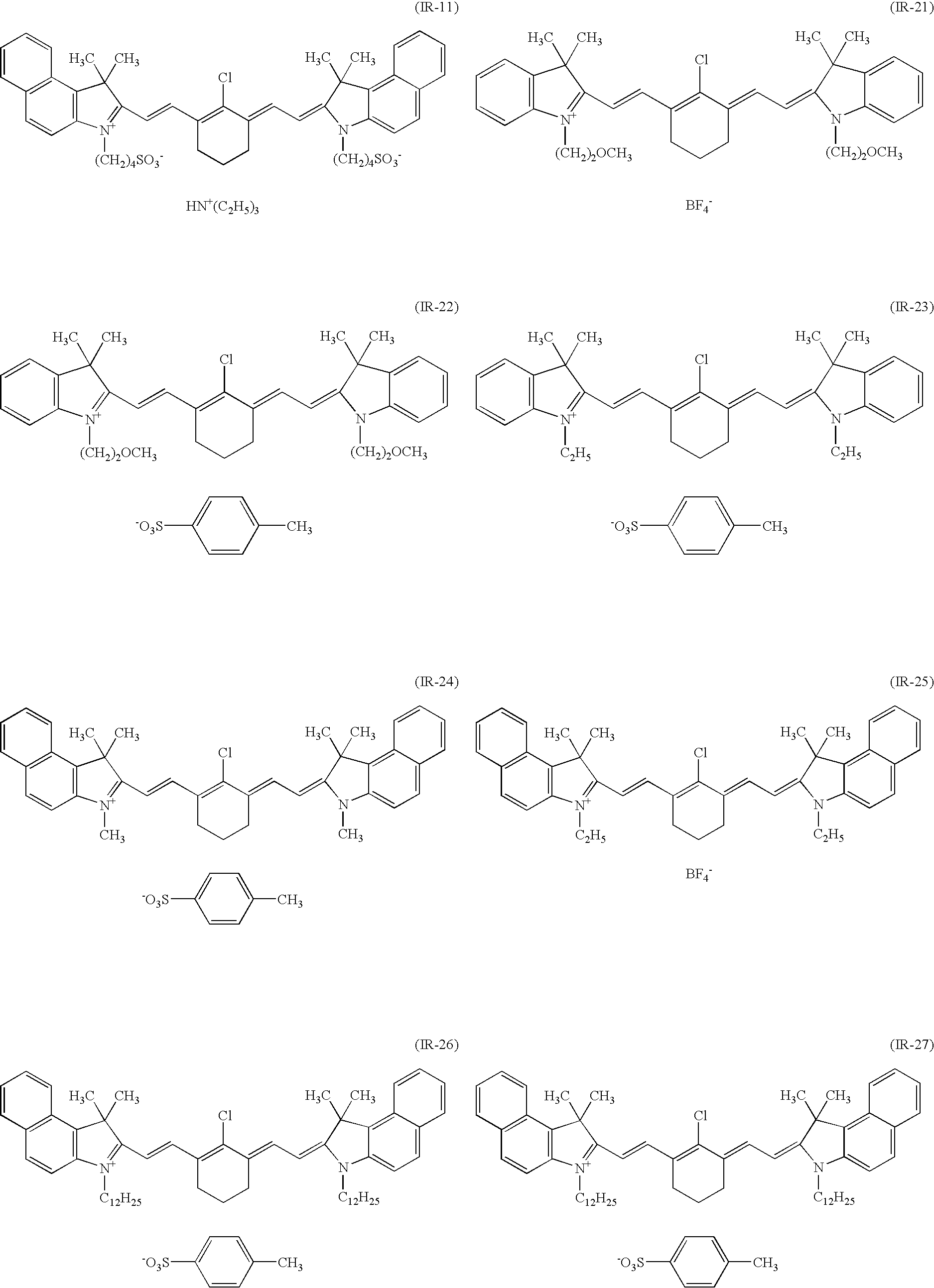

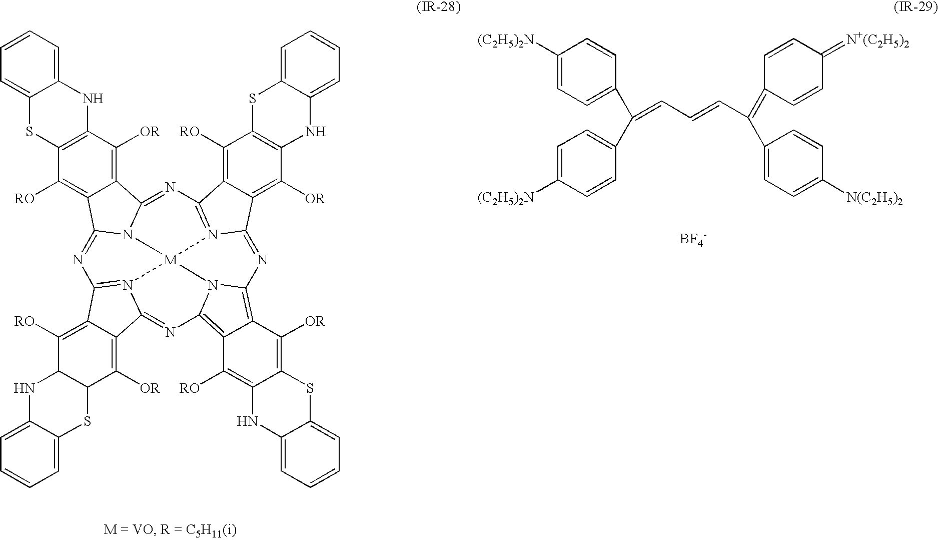

The content of the light-to-heat conversing agent in the microcapsules is preferably from 1% to 50% by mass, and more preferably from 3% to 25% by mass based on the total amount of the microencapsulated materials. On the other hand, the content of the light-to-heat conversing agent in the matrix of the image recording layer is preferably from 1% to 50% by mass, and more preferably 3% to 25% by mass based on the solid content of the recording layer. Such a range may produce the recording layer with good sensitivity without causing reduced film strength.

(Polymerization Initiator)

The matrix of the image recording layer relating to the invention contains the polymerization initiator capable of producing the reaction-initiating substance by the action of heat and causing and progressing the reaction of the polymerizable compound. The polymerization initiator is added at least either inside the microcapsules or to the matrix of the image recording layer. From the viewpoint of stability, the initiator is preferably added to the matrix of the recording layer such that the polymerizable compound can be separated therefrom via the microcapsule wall.

The type of the polymerization initiator for use in the invention may be a known acid or radical generating agent. The acid generator may be used when the polymerizable compound used in the microcapsule is cationically polymerizable, and the radical generating agent may be used when the radical-polymerizable compound is used.

A printing-out system may also be employed in combination with any dye to cause color change by the generated acid or radical.

These polymerization initiators will be described in detail below.

(Acid Generator)

In the invention, the acid generator for use in combination with the cationically polymerizable compound may be any substance that can produce an acid upon absorption of heat. Such an acid generator is preferably any known acid precursor or acid generator, for example, including an acid generator for use in printing-out image formation and an acid generator for use in micro resists.

Specific examples of the acid generator include an organic halogen compound such as a trihalomethyl-substituted heterocyclic compound, a compound that can be decomposed by light to give sulfonic acid, such as iminosulfonate, a disulfone compound, and an onium salt (such as an iodonium salt, a diazonium salt and a sulfonium salt), as disclosed in JP-A Nos. 2002-29162, 2002-46361 and 2002-137562. A polymer compound having the acid-generating group or a compound having the group incorporated in its main or side chain may also be used.

Preferred examples of the acid generator suitable for use in the invention are shown below, but the invention is not limited thereto.

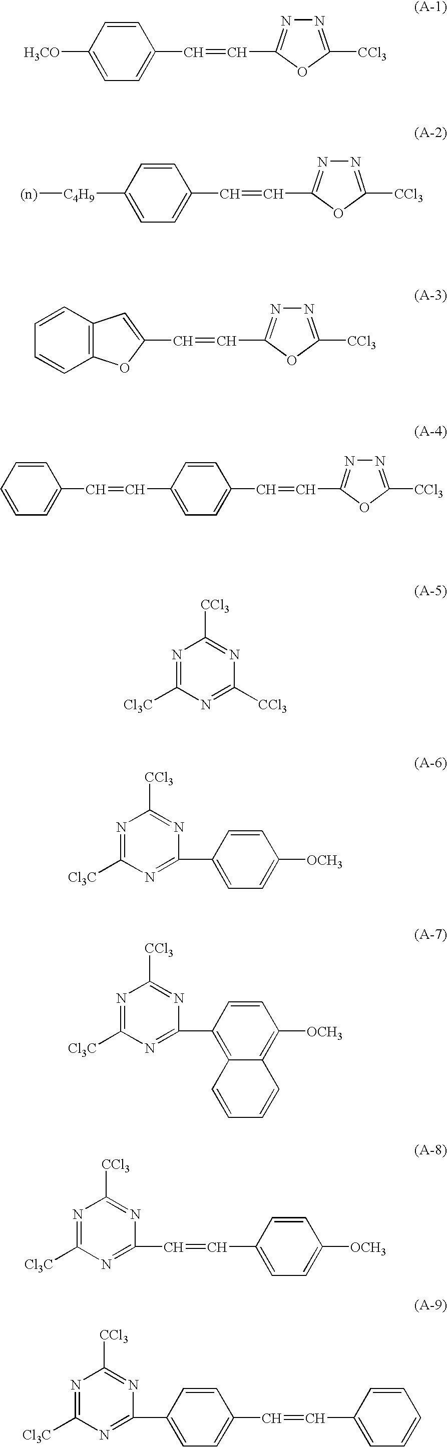

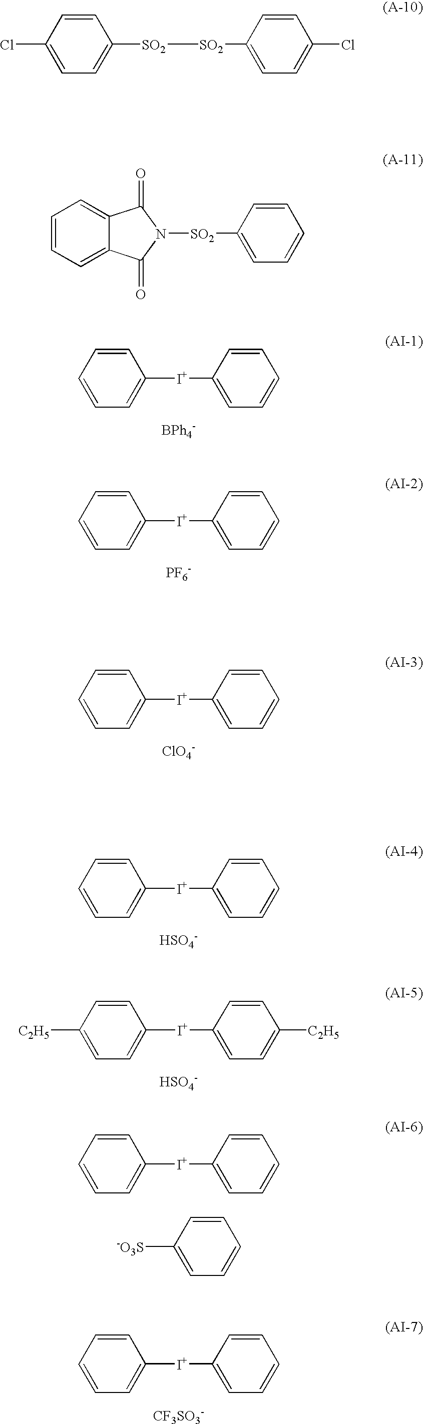

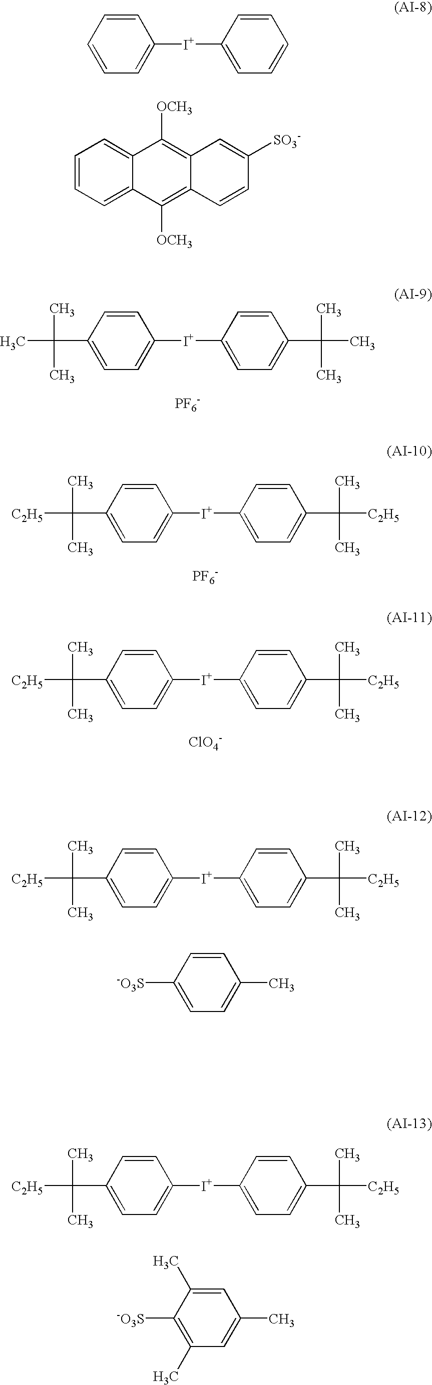

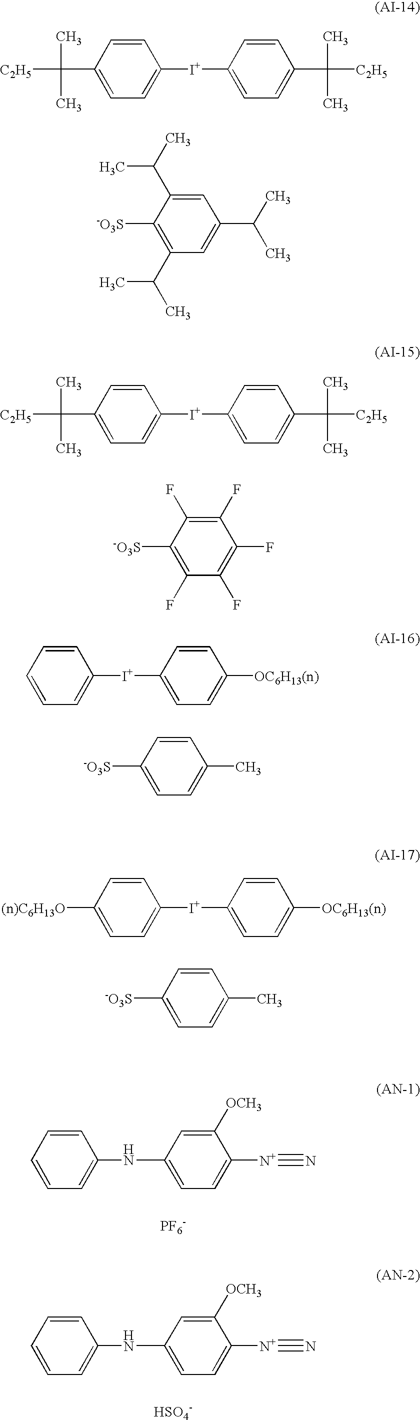

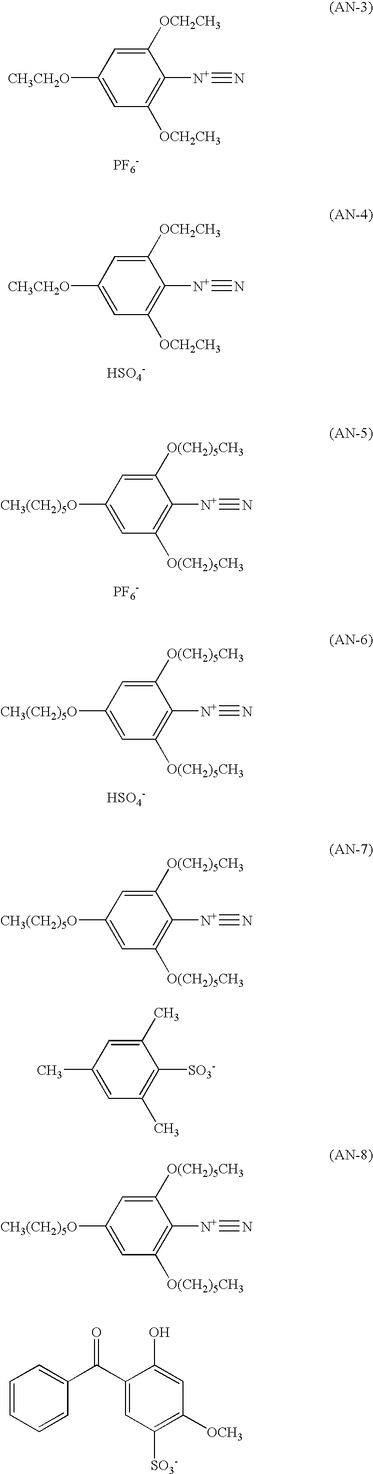

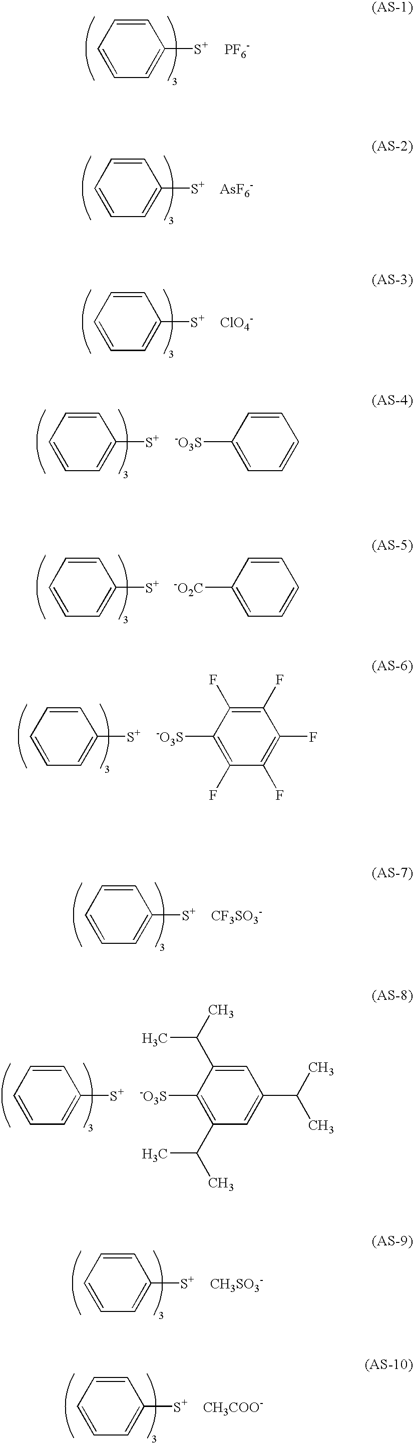

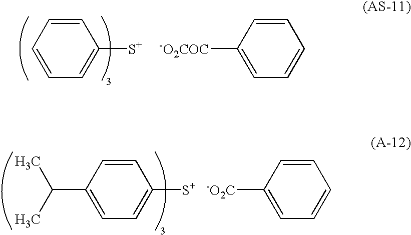

Two or more of the above acid generators may be used in combination.

The content of the acid generator is preferably from 0.01% to 20% by mass, and more preferably from 0.1% to 10% by mass based on the total solid content of the recording layer. The content of the acid generator in the matrix of the image recording layer may be the same. Such a range can exert good effects on starting or promoting the reaction without reducing the on-machine development performance.

(Radical Generating Agent)

In the invention, the radical generating agent for use in combination with the radical-polymerizable compound may be any substance that can produce a radical upon absorption of heat. Such a radical generating agent is preferably any known agent that can generate a radical by the action of heat, for example, including a photo-initiator for radical photopolymerization.

Specific examples of the radical generating agent may include the sulfonic acid-generating compound, the disulfone compound, and the onium salt (such as the iodonium salt, the diazonium salt and the sulfonium salt) as shown above.

Specific examples of the radical generating agent also include, but are not limited to, Compounds (AI-1) to (AI-17), (AN-1) to (AN-8) and (AS-1) to (AS-12) as shown above.

Two or more of the above radical generating agents may be used in combination.

The content of the radical generating agent is preferably from 0.01% to 20% by mass, and more preferably from 0.1% to 10% by mass based on the total solid content of the recording layer. Such a range can exert good effects on starting or promoting the reaction without reducing the on-machine development performance.

In the method according to the first embodiment of the invention, the pre-heating step can cause and progress decomposition of the polymerization initiator (the acid or radical generating agent) to thereby increase the efficiency of the curing reaction between the polymerization initiator and the polymerizable compound that is released to the reaction system when the capsule wall material is made permeable. Therefore, the pre-heating temperature is preferably not lower than the temperature at which decomposition of the polymerization initiator is caused or progressed. More preferably, the pre-heating temperature is at least higher than such a decomposition temperature by 10° C. The decomposition temperature of the polymerization initiator may vary depending on the type of the compound and, for example, is about 160° C. for diphenyliodonium trifluoromethanesulfonate (Acid Generator AI-7 as shown above) and about 200° C. for triphenylsulfonium benzoylformate (Radical generating agent AS-11 as shown above).

In the pre-heating step relating to the invention, the area to be exposed to light and the vicinity thereof are locally heated, at which mobility of the polymerization initiator or the polymerizable compound can be increased, whereby the efficiency of the initiation and progress of the polymerization reaction can be enhanced. After the pre-heating step, therefore, the infrared beam is preferably applied by the time at which the polymerization initiator or the polymerizable compound loses its mobility. In such a case, the pre-heating is preferably completed between one minute prior to the infrared beam irradiation and commencement of irradiation.

In the method according to the second or third embodiment of the invention, the pre-heating step can not only inhibit diffusion of the infrared beam energy for image-wise exposure to the support, but also initiate and progress decomposition of the acid generator, whereby the capsule wall material can be made permeable and that the efficiency of the curing reaction between the cationically polymerizable compound and the acid can be enhanced. Therefore, the pre-heating temperature is preferably not lower than the temperature at which the decomposition of the acid generator is initiated or progressed. The pre-heating temperature is more preferably higher than such a decomposition temperature by at least 10° C. The decomposition temperature of the acid generator may vary depending on the type of the compound and, for example, is about 160° C. for diphenyliodonium trifluoromethanesulfonate (Acid Generator AI-7 as shown above).

The recording layer relating to the invention may contain a compound that cause color change by an acid or a radical for printing-out image formation. Effective examples of such a compound include a variety of coloring matters such as diphenylmethane type, triphenylmethane type, thiazine type, oxazine type, xanthene type, anthraquinone type, iminoquinone type, azo type, and azomethine type coloring matters.

Specific examples thereof include dyes such as Brilliant Green, Ethyl Violet, Methyl Green, Crystal Violet, Basic Fuchsine, Methyl Violet 2B, Quinaldine Red, Rose Bengale, Metanil Yellow, Thymolsulfophthalein, Xylenol Blue, Methyl Orange, Paramethyl Red, Congo Red, Benzopurpurine 4B, α-Naphthyl Red, Nile Blue 2B, Nile Blue A, Methyl Violet, Malachite Green, Parafuchsine, Victoria Pure Blue BOH (manufactured by Hodogaya Chemical Co., Ltd.), Oil Blue #603 (manufactured by Orient Chemical Industries, Ltd.), Oil Pink #312 (manufactured by Orient Chemical Industries, Ltd.), Oil Red 5B (manufactured by Orient Chemical Industries, Ltd.), Oil Scarlet #308 (manufactured by Orient Chemical Industries, Ltd.), Oil Red OG (manufactured by Orient Chemical Industries, Ltd.), Oil Red RR (manufactured by Orient Chemical Industries, Ltd.), Oil Green #502 (manufactured by Orient Chemical Industries, Ltd.), Spiron Red BEH Special (manufactured by Hodogaya Chemical Co., Ltd.), m-cresol purple, Cresol Red, Rhodamine B, Rhodamine 6G, Sulfo Rhodamine B, Auramine, 4-p-diethylaminophenyliminonaphthoquinone, 2-carboxyanilino-4-p-diethylaminophenyliminonaphthoquinone, 2-carboxystearylamino-4-p-N,N-bis(hydroxyethyl)amino-phenyliminonaphthoquinone, 1-phenyl-3-methyl-4-p-diethylaminophenylimino-5-pyrazolone, and 1-β-naphthyl-4-p-diethylaminophenylimino-5-pyrazolone; and leuco dyes such as p,p′,p″-hexamethyltriaminotriphenylmethane (Leuco Crystal Violet) and Pergascript Blue SRB (manufactured by Ciba-Geigy Corp.).

Other preferred examples thereof include leuco dyes known as a material for use in thermal recording paper or pressure sensitive paper. Specific examples of such leuco dyes include Crystal Violet lactone, Malachite Green lactone, Benzoyl Leuco Methylene Blue, 2-(N-phenyl-N-methyl amino)-6-(N-p-tolyl-N-ethyl) aminofluoran, 2-anilino-3-methyl-6-(N-ethyl-p-toluidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N,N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-piperidino-6-methyl-7-anilinofluoran, 3-pyrrolidino-6-methyl-7-anilinofluoran, 3,3-bis(1-ethyl-2-methylindole-3-yl)phthalide, 3,3-bis(1-n-butyl-2-methylindole-3-yl)phthalide, 3,3-bis(p-dimethylaminophenyl)-6-dimethylaminophthalide, 3-(4-diethylamino-2-ethoxyphenyl)-3-(1-ethyl-2-methylindole-3-yl)-4-phthalide, and 3-(4-diethylaminophenyl)-3-(1-ethyl-2-methylindole-3-yl)phthalide.

The content of the dye that can cause color change by an acid or a radical is preferably from 0.01% to 10% by mass based on the solid content of the recording layer.

(Hydrophilic Resin)

The matrix of the recording layer relating to the invention may contain any hydrophilic resin for improving the on-machine development performance and strength of the recording layer itself and for increasing the efficiency of the electromagnetic wave heating.

The hydrophilic resin preferably has such a hydrophilic group as a hydroxyl, amino, carboxyl, phosphoric acid, sulfonic acid, and amide group.

The strength or printing durability of the formed image can further be increased by the crosslinking reaction between the hydrophilic resin and the functional group such as the ethylenically unsaturated group or cationically polymerizable group of the polymerizable compound encapsulated in the microcapsule and the heat-reactive group of the thermally polymerizable compound. Therefore, the hydrophilic resin is preferably selected from the resins having a group that is reactive to such functional groups. If the cationically polymerizable compound has a vinyloxy group or an epoxy group, the hydrophilic resin preferably has a hydroxyl group, a carboxyl group, a phosphoric acid group, a sulfonic acid group, or the like. In particular, the hydrophilic resin preferably has the hydroxyl or carboxyl group.

Examples of the hydrophilic resin include gum arabic, casein, gelatin, starch derivatives, soybean glue, hydroxypropylcellulose, methylcellulose, carboxymethylcellulose and a sodium salt thereof, cellulose acetate, sodium alginate, vinyl acetate-maleic acid copolymers, styrene-maleic acid copolymers, polyacrylic acid and a salt thereof, polymethacrylic acid and a salt thereof, a homopolymer or copolymer of hydroxyethyl methacrylate, a homopolymer or copolymer of hydroxyethyl acrylate, a homopolymer or copolymer of hydroxypropyl methacrylate, a homopolymer or copolymer of hydroxypropyl acrylate, a homopolymer or copolymer of hydroxybutyl methacrylate, a homopolymer or copolymer of hydroxybutyl acrylate, polyethylene glycol, hydroxypropylene polymers, polyvinyl alcohol, hydrolyzed polyvinyl acetate having a hydrolysis degree of at least 60% by mass, preferably at least 80% by mass, polyvinyl formal, polyvinyl pyrrolidone, a homopolymer or copolymer of acrylamide, a homopolymer or copolymer of methacrylamide, a homopolymer or copolymer of N-methylolacrylamide, a homopolymer or copolymer of 2-acrylamide-2-methyl-1-propanesulfonic acid, and a homopolymer or copolymer of 2-methacryloyloxyethylphosphonic acid.

The content of the hydrophilic resin is preferably 20% by mass or less, and more preferably 10% by mass or less, based on the total solid content of the recording layer.

The hydrophilic resin may be used for crosslinking to an extent that the unexposed area can be developed by the printing machine. Examples of the crosslinking agent used for crosslinking the hydrophilic resin include aldehydes such as glyoxal, melamine-formaldehyde resins, and urea-formaldehyde resins; methylol compounds such as N-methylolurea, N-methylolmelamine and methylolated polyamide resins; active vinyl compounds such as divinylsulfone and bis(β-hydroxyethylsulfonic acid); epoxy compounds such as epichlorohydrin, polyethylene glycol diglycidyl ether, polyamide, polyamine, epichlorohydrin adducts, and polyamide-epichlorohydrin resins; ester compounds such as monochloroacetate ester and thioglycolate ester; polycarboxylic acid such as polyacrylic acid and a methyl vinyl ether-maleic acid copolymer; inorganic crosslinking agents such as boric acid, titanyl sulfate and a Cu, Al, Sn, V, or Cr salt; and a modified polyamide-polyimide resin. Any crosslinking catalyst such as ammonium chloride, a silane coupling agent and a titanate coupling agent may also be used in combination.

Other Additives

If desired, any additives other than the above compounds may be added to the matrix of the recording layer relating to the invention.

(Hydrophobic Resin)

The matrix of the recording layer relating to the invention may contain a hydrophobic resin for enhancing layer strength at the image areas.

The hydrophobic resins usable in the matrix may be any conventionally known hydrophobic resins, without any limitation. Specifically, linear organic polymers that exhibit film-forming ability are preferably used. Illustrative examples of the linear organic polymer include acrylic resin, poly(vinyl acetal) resin, polyurethane resin, polyurea resin, polyimide rein, polyamide resin, epoxy resin, methacrylic resin, polystyrene-type resin, novolak-based phenol-type resin, polyester resin, synthetic rubber and natural rubber.

In order to further improve the layer strength at the image areas, the hydrophobic resins preferably have a heat-reactive group. For example, the polymers in which an ethylenically unsaturated bond has been introduced into the main chain or the side chain can be used. Suitable examples of the polymer in which the ethylenically unsaturated bond has been introduced into the main chain include poly-1,4-butadiene and poly-1,4-isoprene. And representative examples of the polymer in which the ethylenically unsaturated bond has been introduced into the side chain include the polymers of the ester or amide of an acrylic acid or a methacrylic acid, in which the residue of the ester or amide (R of —COOR or —CONHR) has the ethylenically unsaturated bond.

(Polyfunctional Monomer)

Any polyfunctional monomer may be added in order to further increase the printing durability. Such a polyfunctional monomer may be the same as any of the above monomers to be microencapsulated. In particular, such a monomer is preferably trimethylolpropane triacrylate, pentaerythritol triacrylate or the like. The content of the polyfunctional monomer is preferably from 0.1% to 10% by mass, and more preferably from 0.5% to 5.0% by mass based on the total solid content of the recording layer.

(Thermopolymerization Inhibitor)

In the invention, a small amount of a thermopolymerization inhibitor is preferably used in order to prevent undesired thermopolymerization of the ethylenically unsaturated compound during preparation or storage of the coating liquid for the recording layer. Suitable examples of the thermopolymerization inhibitor include hydroquinone, p-methoxyphenol, di-tert-butyl-p-cresol, pyrogallol, tert-butylcatechol, benzoquinone, 4,4′-thiobis(3-methyl-6-tert-butylphenol), 2,2′-methylenebis(4-methyl-6-tert-butylphenol), and N-nitroso-N-phenylhydroxylamine aluminum salt. The content of the thermopolymerization inhibitor is preferably from 0.01% to 5% by mass based on the total solid content of the recording layer.

(Higher Fatty Acid or Derivatives Thereof)

If desired, any higher fatty acid such as behenic acid or any derivatives thereof such as behenic acid amide may be added to the matrix of the recording layer and omni-present at the surface of the recording layer during a drying process such that polymerization inhibition caused by oxygen can be prevented. The content of the higher fatty acid or the derivative thereof is preferably from 0.1% to 10% by mass based on the total solid content of the recording layer.

(Fine Inorganic Particles)

The matrix of the recording layer relating to the invention may contain fine inorganic particles. Preferred examples of the material for the fine inorganic particles include silica, alumina, magnesium oxide, titanium oxide, magnesium carbonate, calcium alginate, and any mixture thereof. Such a material can be used for strengthening the coat or enhancing the interfacial adhesion by making a rough surface, even if it does not have light-to-heat convertibility.

The fine inorganic particles preferably have an average particle diameter of from 5 nm to 10 μm, and more preferably from 10 nm to 1 μm. If such a range of the particle diameter is employed, the fine particles can stably be dispersed in the hydrophilic resin together with the microcapsules or the fine metal particles of the light-to-heat conversing agent, whereby a sufficient strength of the recording layer can be maintained and the non-image portion that exhibits high hydrophilicity without having stains can be formed on the print.

Such fine inorganic particles are readily available as a commercial product, such as a colloidal silica dispersion. The content of the fine inorganic particles in the recording layer is preferably 20% by mass or less, and more preferably 10% by mass or less, based on the total solid content of the recording layer.

(Surfactant)

In order to improve dispersion stability of the recording layer or improve plate-making or printing performances, the matrix of the recording layer relating to the invention may contain a nonionic, anionic, cationic, amphoteric, or fluorinated surfactant, as disclosed in JP-A Nos. 02-195356, 59-121044 and 04-13149 and Japanese Patent Application No.2001-169731. The content of the surfactant is preferably from 0.005% to 1% by mass based on the total solid content of the recording layer.

(Plasticizer)

If desired, any plasticizer may be added to the matrix of the recording layer relating to the invention, so as to provide plasticity or the like for the coating. Examples of the plasticizer include polyethylene glycol, tributyl citrate, diethyl phthalate, dibutyl phthalate, dihexyl phthalate, dioctyl phthalate, tricresyl phosphate, tributyl phosphate, trioctyl phosphate, and tetrahydrofurfuryl oleate.

(Preparation of Image Recording Layer)

The recording layer relating to the invention can be formed by a process comprising the steps of dissolving the necessary materials as shown above in a solvent to form a coating liquid and applying the resultant solution. Examples of the solvent for use in such a process include, but are not limited to, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, toluene, and water. Any of these solvents may be used alone or in combination. The solid content of the coating liquid is preferably from 1% to 50% by mass.

The coating amount (in respect of solids) of the recording layer formed after application and drying of the coating may vary depending on the use and is generally preferably from 0.5 to 5.0 g/m². If the coating amount is less than this range, apparent sensitivity may be increased, but the coating characteristics of the recording layer for performing the function of recording an image may be degraded. A variety of methods can be used for application of the coating, for example, bar coating, rotary coating, spray coating, curtain coating, dip coating, air knife coating, blade coating, and roll coating.

(Overcoat Layer)

An overcoat layer containing a water-soluble resin, as disclosed in JP-A Nos. 2001-162961 and 2002-19318, may be formed on the recording layer of the planographic printing plate precursor relating to the invention. The overcoat layer can protect the hydrophilic surface of the recording layer from being stained by the lipophilic substance during storage, or from being stained by fingerprints or the like by contact with hand or fingers during handling.

Examples of the water-soluble resin for use in the overcoat layer include, but are not limited to, natural polymers such as gum arabic, water-soluble soybean polysaccharides, cellulose derivatives (such as carboxymethylcellulose, carboxyethylcellulose and methylcellulose) or modifications thereof, white dextrin, plluran, and enzyme-decomposed etherified dextrin; and synthetic polymers such as polyvinyl alcohol (with a hydrolysis rate of 65% or more from polyvinyl acetate), polyacrylic acid or an alkali metal or amine salt thereof, a polyacrylic acid copolymer or an alkali metal or amine salt thereof, polymethacrylic acid or an alkali metal or amine salt thereof, a vinyl alcohol/acrylic acid copolymer or an alkali metal or amine salt thereof, polyacrylamide or a copolymer thereof, polyhydroxyethyl acrylate, polyvinyl pyrrolidone or a copolymer thereof, polyvinyl methyl ether, a vinyl methyl ether/ maleic anhydride copolymer, poly-2-acrylamide/2-methyl-1-propanesulfonic acid or an alkali metal or amine salt thereof, and a poly-2-acrylamide/2-methyl-l-propanesulfonic acid copolymer or an alkali metal or amine salt thereof. Two or more of these resins may be mixed for use depending on the purpose.

The overcoat layer may contain a light-to-heat conversing agent for increasing sensitivity. The photothermal agent is preferably a water-soluble, infrared absorbing dye. Preferred examples of such a light-to-heat conversing agent include Compounds (IR-1) to (IR-11) as shown above for the recording layer.

For the purpose of ensuring uniform application of the overcoat layer, any nonionic surfactant may mainly be added to an aqueous solution to be applied. Examples of such a nonionic surfactant include sorbitan tristearate, sorbitan monopalmitate, sorbitan trioleate, stearic acid monoglyceride, polyoxyethylenenonylphenyl ether, and polyoxyethylenedodecyl ether. The nonionic surfactant preferably accounts for 0.05% to 5% by mass, and more preferably 1% to 3% by mass of the total solid of the overcoat layer.

The overcoat layer may also contain a compound having any of fluorine and silicon atoms, as disclosed in JP-A No. 2001-341448, such that sticking between the stacked plates can be prevented during storage.

A thickness of the overcoat layer relating to the invention is preferably from 0.1 to 4.0 μm, and more preferably from 0.1 to 1.0 μm. By employing such a range, the recording layer can be prevented from being stained by the lipophilic substance without losing peelability of the overcoat layer on the printing machine.

(Support)

Any plate-shaped material having dimensional stability can be used as the support of the planographic printing plate precursor according to the invention. Examples of the material for the support include paper, paper laminated with a plastic (such as polyethylene, polypropylene and polystyrene), a plate of metal (such as aluminum, zinc and copper), a film of plastic (such as cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinyl acetal), and a paper or plastic film laminated or vapor-deposited with the above metal. A preferred support is an aluminum plate.

The aluminum plate may be a pure aluminum plate, an aluminum alloy plate comprising aluminum as a main component and a minute amount of a foreign element, or a plastic-laminated aluminum or aluminum alloy thin film. Examples of the foreign element in the aluminum alloy include silicon, iron, manganese, copper, magnesium, chromium, zinc, bismuth, nickel, and titanium. The content of the foreign element in the aluminum alloy should be at most about 10% by mass. The aluminum plate may be produced from an aluminum ingot by DC casting or continuous casting. Any conventional aluminum plate can be appropriately used in the invention.

The support for use in the invention may have a thickness of from 0.05 mm to 0.6 mm, preferably from 0.1 mm to 0.4 mm, and particularly preferably from 0.15 mm to 0.3 mm.

The aluminum plate is preferably subjected to a surface treatment such as a surface-roughening treatment and anodic oxidation before use. The surface treatment can facilitate improved hydrophilicity and adhesion to the recording layer.

A variety of methods may be used to roughen the surface of the aluminum plate, for example, a method of mechanically roughening the surface, a method of electrochemically dissolving and roughening the surface, and a method of chemically selectively dissolving the surface. Examples of the mechanically roughening method include such known methods as a ball polishing method, a brush polishing method, a blasting method, and a buffing method. For example, the chemical method is appropriately a method including the step of immersing the aluminum plate in an aqueous solution saturated with an aluminum salt of a mineral acid as disclosed in JP-A No. 54-31187. For example, the electrochemically roughening method is a method including the step of applying alternating current or direct current to the plate in an electrolytic solution containing an acid such as hydrochloric acid and nitric acid. Another applicable method is a method of roughening the surface through electrolysis using a mixed acid as disclosed in JP-A No. 54-63902. Any of the above surface-roughening methods is preferably performed in such an extent that the central line average surface roughness (Ra) of the aluminum plate surface reaches a value of from 0.2 to 1.0 μm.

If desired, the roughened aluminum plate may be subjected to alkali-etching process with an aqueous solution of potassium hydroxide or sodium hydroxide and then subjected to neutralizing treatment. Thereafter, if desired, the plate may be subjected to anodic oxidation in order to exhibit increased abrasion resistance.

A variety of electrolytes may be used for forming a porous oxide film in the anodic oxidation of the aluminum plate. In general, sulfuric acid, hydrochloric acid, oxalic acid, chromic acid, or any mixed acid thereof is used as the electrolyte. The concentration of the electrolyte is appropriately specified depending on the type of the electrolyte used. The conditions of the anodic oxidation process may vary depending on the type of the electrolyte and cannot be specified generally. Usually, suitable conditions thereof are: an electrolyte concentration of from 1 to 80% by mass of the solution; a liquid temperature of from 5 to 70° C.; an electric current density of from 5 to 60 A/dm²; a voltage of from 1 to 100 V; and an electrolysis time of from 10 seconds to 5 minutes. The amount of the formed oxide film is preferably from 1.0 to 5.0 g/m², particularly preferably from 1.5 to 4.0 g/m².

In the invention, the surface-treated substrate provided with the anodic oxidation film may be used as the support without undergoing any post-process. If desired, however, any appropriate treatment may be selected and performed to further improve adhesion to the additional layer, hydrophilicity, resistance to soiling, heat insulating properties, or the like. Examples of such a treatment include a treatment for enlarging the micro-pores of the anodic oxidation film, a treatment for sealing the micro-pores, and a treatment for making the surface turn hydrophilic by immersing the support in an aqueous solution containing a hydrophilic compound, as disclosed in JP-A Nos. 2001-253181 and 2001-322365.

Preferred examples of the hydrophilic compound for the hydrophilizing treatment include polyvinylphosphonic acid, a sulfonic acid group-containing compound, saccharides, citric acid, alkali metal silicate, zirconium potassium fluoride, and phosphate/inorganic fluoride.

If a material having insufficient surface hydrophilicity, such as a polyester film, is used as the support, a hydrophilic layer should preferably be formed to make a hydrophilic surface. As disclosed in JP-A No. 2001-199175, the hydrophilic layer is preferably formed by applying a coating liquid that contains a colloidal oxide or hydroxide of at least one element selected from beryllium, magnesium, aluminum, silicon, titanium, boron, germanium, tin, zirconium, iron, vanadium, antimony, and transition metals. In particular, the hydrophilic layer is preferably formed by applying a coating liquid that contains a colloidal oxide or hydroxide of silicon.

If desired, an undercoat layer may be formed before the recording layer has been formed. Such an undercoat layer may be an inorganic layer made of a water-soluble metal salt such as zinc borate or an organic layer containing carboxymethylcellulose, dextrin, polyacrylic acid, or the like, as disclosed in JP-A No. 2001-322365. The undercoat layer may contain the light-to-heat conversing agent.

The planographic printing plate precursor produced as described above can be used in the inventive method. Such a planographic printing plate precursor is the on-machine development type that can be subjected to the printing process without undergoing any independent development process after an image is formed on the plate by infrared-ray irradiation.

In the image forming method according to the present invention, an image portion having a sufficient strength can be formed on the planographic printing plate precursor having the above-mentioned structure by conducting image exposure process using infrared light. The planographic printing plate precursor having the above structure and applicable to the on-machine development can exhibit improved printing durability and is used in producing a large number of high-quality image prints.

### EXAMPLES

The present invention is described in more detail with reference to the examples below, which are not intended to limit the scope of the invention.

Preparation of Support

A molten JIS A1050 alloy containing at least 99.5% by mass of aluminum, 0.30% by mass of Fe, 0.10% by mass of Si, 0.02% by mass of Ti, and 0.013% by mass of Cu was subjected to purification treatment and then cast. The purification treatment included degassing treatment for removing unnecessary gas such as hydrogen from the molten metal and ceramic tube filter treatment. The alloy was cast by DC casting method. The solidified metal was made into an ingot with a thickness of 500 mm. The surface portion 10 mm in thickness was ground away from the ingot, and homogenizing treatment was performed at 550° C. for 10 hours so as to prevent the intermetallic compound from being coarsened.

The ingot was then hot-rolled at 400° C., intermediately annealed at 500° C. for 60 seconds, and cold-rolled into a rolled aluminum plate with a thickness of 0.30 mm. The roughness of the pressure roll was controlled to render a central line average roughness (Ra) of the cold-rolled plate surface to be 0.2 μm. The plate was then subjected to a tension leveller to improve flatness.

The plate was surface-treated to give a support for a planographic printing plate. First, the aluminum plate was subjected to degreasing treatment with an aqueous solution of 10% by mass sodium aluminate at 50° C. for 30 seconds to remove the rolling oil from the surface of the aluminum plate. After neutralization with an aqueous solution of 30% by mass sulfuric acid at 50° C. for 30 seconds, desmutting treatment was performed. The surface of the support was then subjected to a so-called graining treatment, i.e., surface-roughening treatment, for the purpose of providing good adhesion of the support to the recording layer and giving water retentivity to the non-image portion. The graining treatment was electrolytically performed through a process including the steps of: keeping, at 45° C., an aqueous solution containing 1% by mass of nitric acid and 0.5% by mass of aluminum nitrate; and applying, from an indirect power supply cell to the plate, an anode side electrical quantity of 240 C/dm² in an alternating waveform with a current density of 20 A/dm² and an duty ratio of 1:1, while allowing an aluminum web to pass through the aqueous solution. The plate was then subjected to etching with an aqueous solution of 10% by mass sodium aluminate at 50° C. for 30 seconds, subjected to neutralization with an aqueous solution of 30% by mass sulfuric acid at 50° C. for 30 seconds, and then subjected to desmutting treatment. For the purpose of increasing abrasion resistance, chemical resistance or water retentivity, an oxide film was formed on the support by anodic oxidation, which included the steps of: using an aqueous solution of 20% by mass sulfuric acid as an electrolyte at 35° C.; allowing an aluminum web to travel through the electrolyte; and performing electrolysis treatment by applying a direct current of 14 A/dm² from an indirect power supply cell to form 2.5 g/m² of an anodic oxidation film.

For the purpose of ensuring the hydrophilicity at the non-image portion of the printing plate, silicate treatment was then performed, which included the steps of: keeping, at 70° C., an aqueous solution of 1.5% by mass disodium trisilicate; allowing an aluminum web to travel through the solution in such a manner that the aluminum web contact time was set at 15 seconds; and performing washing with water. The amount of the deposited Si was 10 mg/m². The surface of the support prepared as above had a central line average roughness (Ra) of 0.25 μm.

Preparation of Cationically Polymerizable Compound-Encapsulating Microcapsule A

In 18.4 g of ethyl acetate were dissolved 4.5 g of bis(vinyloxyethyl)ether of bisphenol A, 5 g of an adduct of trimethylolpropane and xylylene diisocyanate (Takenate D-110N manufactured by Mitsui Takeda Chemicals, Inc., a microcapsule wall material), 3.75 g of Millionate MR-200 (an aromatic isocyanate oligomer manufactured by Nippon Polyurethane Industry Co., Ltd., a microcapsule wall material), 1.5 g of an infrared absorbing dye (IR-27 as shown above), and 0.1 g of Pionin A41C (a surfactant manufactured by Takemoto Oil & Fat Co., Ltd.) to form an oil phase component. A water phase component was 37.5 g of an aqueous solution of 4% by mass PVA 205 (polyvinyl alcohol manufactured by Kuraray Co., Ltd.). The oil phase component and the water phase component were emulsified using a homogenizer at 12,000 rpm for 10 minutes. Thereafter, a mixture of 26 g of water and 0.38 g of tetraethylenepentamine (pentafunctional amine, a microcapsule wall-crosslinking agent) was added to the resultant emulsion, which was then stirred for 30 minutes under water cooling and further stirred at 65° C. for 3 hours. The resulting microcapsule liquid (microcapsule solution A) had a solid content of 24% by mass and an average particle diameter of 0.3 μm.

Preparation of Radical-Polymerizable Compound-Encapsulating Microcapsule B

In 18.4 g of ethyl acetate were dissolved 4.5 g of dipentaerythritol tetraacrylate (KAYARAD DPHA manufactured by Nippon Kayaku Co., Ltd.), 5 g of an adduct of trimethylolpropane and xylylene diisocyanate (Takenate D-110N manufactured by Mitsui Takeda Chemicals, Inc., a microcapsule wall material), 3.75 g of Millionate MR-200 (an aromatic isocyanate oligomer manufactured by Nippon Polyurethane Industry Co., Ltd., a microcapsule wall material), 1.5 g of an infrared absorbing dye (IR-27 as shown above), and 0.1 g of Pionin A41C (a surfactant manufactured by Takemoto Oil & Fat Co., Ltd.) to form an oil phase component. A water phase component was 37.5 g of an aqueous solution of 4% by mass PVA 205 (polyvinyl alcohol manufactured by Kuraray Co., Ltd.). The oil phase component and the water phase component were emulsified using a homogenizer at 12,000 rpm for 10 minutes. Thereafter, a mixture of 26 g of water and 0.38 g of tetraethylenepentamine (pentafunctional amine, a microcapsule wall-crosslinking agent) was added to the resultant emulsion, which was then stirred for 30 minutes under water cooling and further stirred at 65° C. for 3 hours. The resulting microcapsule liquid (microcapsule solution B) had a solid content of 24% by mass and an average particle diameter of 0.3 μm.

### Example 1

Preparation of Planographic Printing Plate Precursor A

A coating liquid for a recording layer, containing the thus prepared microcapsule solution A and having the following composition, was applied by bar coating to the aluminum substrate prepared as above and then dried at 100° C. for 60 seconds in an oven, whereby a planographic printing plate precursor (Planographic Printing Plate Precursor A) provided with a recording layer having a dry coating amount of 1.0 g/m² was prepared.

Coating Liquid for Recording Layer

| | |
|---|---|
| Water | 35.4 g |
| Microcapsule Solution A | 9.0 g |
| Acid Generator (AI-7 as Shown Above) | 0.24 g |

### Example 2

Preparation of Planographic Printing Plate Precursor B

A coating liquid for a recording layer, containing the thus prepared microcapsule solution B and having the following composition, was applied by bar coating to the aluminum substrate prepared as above and then dried at 100° C. for 60 seconds in an oven, whereby a planographic printing plate precursor (Planographic Printing Plate Precursor B) provided with a recording layer having a dry coating amount of 1.0 g/m² was prepared.

Coating Liquid for Recording Layer

| | |
|---|---|
| Water | 35.4 g |
| Microcapsule Solution B | 9.0 g |
| Acid Generator (AS-11 as Shown Above) | 0.24 g |

Exposure, Printing and Evaluation

Planographic Printing Plate Precursor A or B was placed in the inventive image exposure apparatus 10 as shown above with reference to FIGS. 1 and 2. The pre-heat region of the recording layer in the planographic printing plate precursor was pre-heated to bring to a temperature of 160° C. to 180° C. and then, 25 seconds later, subjected to image-wise exposure in Trendsetter 3244VX (manufactured by CREO Co., Ltd.) equipped with a water-cooled 40 W infrared semiconductor laser under the conditions of an output power of 17 W, an exterior drum rotational speed of 100 rpm, and a resolution of 2,400 dpi. During the exposure process, the temperature of the pre-heat region of the recording layer in the planographic printing plate precursor was kept at 100° C. or higher. The reaction effectively proceeded to make the capsule permeable and to produce an acid or a radical from the polymerization initiator. Since the polymerizable compound and the active species had high mobility, the obtained image had firm and good printing durability.

After image-wise exposure was completed, each planographic printing plate precursor of respective Examples was mounted on a cylinder of a printing machine SOR-M (manufactured by Heidelberg). A wetting solution comprising an aqueous solution of 4% by volume IF102 (manufactured by Fuji Photo Film Co., Ltd.) and a Values tusche ink (manufactured by Dainippon Ink and Chemicals, Incorporated) were used for printing. After the wetting solution was supplied, the ink was charged and then sheets of paper were fed for printing.

The non-image portion of the recording layer was removed at an early stage of the printing process, and a high-quality image print was produced with no stain on the non-image portion. The printing was repeated, and the obtained prints were evaluated visually for the sheet number having no stain on the non-image portion and with a sufficient ink concentration on the image portion in order to be used as an index for printing durability. If a larger number was obtained, it was rated as exhibiting better printing durability.

Example 1 produced 35,000 prints of Planographic Printing Plate Precursor A, and Example 2 produced 25,000 prints of Planographic Printing Plate Precursor B. These results reveal that both planographic printing plate precursors of Examples 1 and 2 have good printing durability that are suitably for practical use.

The support was prepared and subjected to surface treatment, in a similar manner to the process as described above.

Then, silicate treatment was performed to ensure hydrophilicity at the non-image portion of the printing plate. The treatment included the steps of: keeping, at 70° C., an aqueous solution of 1.5% by mass disodium trisilicate; allowing an aluminum web to travel through the solution in such a manner that the aluminum web contact time was set at 15 seconds; and performing washing with water. Si was deposited in an amount of 10 mg/m². The surface of the support prepared as above had a central line average roughness (Ra) of 0.25 μm.

Preparation of Cationically Polymerizable Compound-Encapsulating Microcapsule C

In 18.4 g of ethyl acetate were dissolved 4.5 g of bis(vinyloxyethyl)ether of bisphenol A, 5 g of an adduct of trimethylolpropane and xylylene diisocyanate (Takenate D-110N manufactured by Mitsui Takeda Chemicals, Inc., a microcapsule wall material), 3.75 g of Millionate MR-200 (an aromatic isocyanate oligomer manufactured by Nippon Polyurethane Industry Co., Ltd., a microcapsule wall material), 1.5 g of an infrared absorbing dye (IR-27 as shown above), and 0.1 g of Pionin A41C (a surfactant manufactured by Takemoto Oil & Fat Co., Ltd.) to form an oil phase component. A water phase component was 37.5 g of an aqueous solution of 4% by mass PVA 205 (polyvinyl alcohol manufactured by Kuraray Co., Ltd.). The oil phase component and the water phase component were emulsified using a homogenizer at 12,000 rpm for 10 minutes. Thereafter, a mixture of 26 g of water and 0.38 g of tetraethylenepentamine (pentafunctional amine, a microcapsule wall-crosslinking agent) was added to the resultant emulsion, which was then stirred for 30 minutes under water cooling and further stirred at 65° C. for 3 hours. The resulting microcapsule liquid (microcapsule solution C) had a solid content of 24% by mass and an average particle diameter of 0.3 μm.

### Example 3

Preparation of Planographic Printing Plate Precursor

A coating liquid for a recording layer, containing the thus prepared microcapsule solution and having the following composition, was applied by bar coating to the aluminum substrate prepared as above and then dried at 100° C. for 60 seconds in an oven, whereby a planographic printing plate precursor provided with a recording layer having a dry coating amount of 1.0 g/m² was prepared.

Coating Liquid for Recording Layer

| | |
|---|---|
| Water | 35.4 g |
| Microcapsule Solution C | 9.0 g |
| Acid Generator (AI-7 as Shown Above) | 0.24 g |

Exposure, Printing and Evaluation

The resulting planographic printing plate precursor was placed in the inventive image exposure apparatus 10 according to the second embodiment of the invention with reference to FIGS. 3 to 7, or the exposure apparatus 100 according to the third embodiment of the invention with reference to FIG. 8. In the apparatus, the planographic printing plate precursor was pre-heated to bring to a temperature of 160° C. to 180° C. and then, 30 to 100 seconds later, subjected to image-wise exposure in Trendsetter 3244VX (manufactured by CREO Co., Ltd.) equipped with a water-cooled 40 W infrared semiconductor laser under the conditions of an output power of 17 W, an exterior drum rotational speed of 100 rpm, and a resolution of 2,400 dpi. During the exposure process, the temperature of the contact surface between the support (the aluminum plate) and the recording layer of the planographic printing plate precursor and the surface temperature of the image recording layer were kept at 70° C. or higher, whereby in the planographic printing plate, thermal diffusion from the exposure area in the recording layer to the support was effectively inhibited during the exposure process using the IR laser L beam. As a result, the disintegration of the microcapsule wall or an increase in the permeability of the microcapsule wall effectively proceeded, and the decomposition reaction of the acid generator was also be enhanced. Furthermore, mobility of the cationically polymerizable compound was increased to thereby efficiently proceed the polymerization and the curing reaction. The obtained image had firm and good printing durability.

After image-wise exposure was completed, the planographic printing plate precursor was mounted on a cylinder of a printing machine SOR-M (manufactured by Heidelberg) without undergoing any particular development process. A wetting solution comprising an aqueous solution of 4% by volume IF102 (manufactured by Fuji Photo Film Co., Ltd.) and a Values tusche ink (manufactured by Dainippon Ink and Chemicals, Incorporated) were used for printing. After the wetting solution was supplied, the ink was charged and then sheets of paper were fed for printing.

The non-image portion of the recording layer was removed at an early stage of the printing process, and a high-quality image print was produced with no stain on the non-image portion. The printing was repeated, and the obtained prints were visually evaluated for the sheet number having no stain on the non-image portion and with a sufficient ink concentration on the image portion in order to be used as an index for printing durability. If a larger number was obtained, it was rated as exhibiting better printing durability.

In this example, 35,000 prints having high-quality image were produced. The results confirm that the planographic printing plate precursor, on which an image is formed by the method according to the invention, has good printing durability that is suitably for practical use.

As detailed above, the present inventive provides an image forming method on a planographic printing plate precursor for plate-making in which an image is exposed to light by scanning with an infrared beam and which obviates development using any developing liquid, as well as an image exposure apparatus suitably used in the image forming method.

What is claimed is:

1. An image forming method on a planographic printing plate precursor including a support having disposed thereon an image recording layer that contains polymerizable compound-encapsulating microcapsules, a polymerization initiator, and a light-to-heat conversing agent, comprising the steps of:
irradiating the planographic printing plate precursor with an infrared beam to form an image in the recording layer of the planographic printing plate precursor; and
prior to irradiating an area with the infrared beam, carrying out pre-heating at a pre-heat region including the irradiation area in the image recording layer to locally bring to a pre-heat temperature, wherein the pre-heating step has been completed before the infrared beam irradiation is started.

2. The image forming method according to claim 1, wherein the step of pre-heating is completed between one minute prior to the infrared beam irradiation and commencement of irradiation.

3. The image forming method according to claim 1, wherein the step of pre-heating is completed between 30 seconds prior to the infrared beam irradiation and commencement of irradiation.

4. The image forming method according to claim 1, wherein the pre-heat temperature in the pre-heating step is in the range of 50° C. to 230° C.

5. The image forming method according to claim 2, wherein the pre-heat temperature in the pre-heating step is in the range of 50° C. to 230° C.

6. The image forming method according to claim 3, wherein the pre-heat temperature in the pre-heating step is in the range of 50° C. to 230° C.

7. An image exposure apparatus used in the image forming method on a planographic printing plate precursor which includes a support having disposed thereon an image recording layer that contains polymerizable compound-encapsulating microcapsules, a polymerization initiator, and a light-to-heat conversing agent, comprising:
a holding member that holds an attachable planographic printing plate precursor to the apparatus;
an irradiating unit that irradiates the held planographic printing plate precursor with an infrared beam to form an image in the image recording layer of the held planographic printing plate precursor; and
a pre-heating unit that locally heats a pre-heat region including an irradiation area of the planographic printing plate precursor to bring to a pre-heat temperature before performing the infrared beam irradiation.

8. The image forming apparatus according to claim 7, wherein pre-heating is completed between one minute prior to the infrared beam irradiation and commencement of irradiation.

9. The image forming apparatus according to claim 7, wherein pre-heat temperature in the pre-heating step is in the range of from 50° C. to 230° C.

10. The image exposure apparatus according to claim 7, wherein the irradiating unit comprises: an exposing head to form an infrared beam spot on the planographic printing plate precursor held by the holding member; a carrier member on which the exposing head is mounted; and a feeding system to allow movement of the exposing head together with the carrier member in a sub-scanning direction at the time of irradiating the planographic printing plate precursor with the beam, and
wherein the pre-heating unit comprises a heat supplying unit that is mounted on the carrier member to be located downstream of the exposing head in the sub-scanning direction so as to supply thermal or electromagnetic energy to the pre-heat region and thereby heating the region to bring to the pre-heat temperature while moving together with the exposing head in the sub-scanning direction at the time of irradiating the planographic printing plate precursor with the beam.

11. An image forming method on a planographic printing plate precursor including a support having disposed thereon an image recording layer that contains cationically polymerizable compound-encapsulating microcapsules, an acid generator, and a light-to-heat conversing agent, comprising the steps of:
carrying out pre-heating of the planographic printing plate precursor to bring to a pre-heat temperature; and
irradiating the pre-heated planographic printing plate precursor with an infrared beam to form an image in the image recording layer of the planographic printing plate precursor.

12. The image forming method according to claim 11, wherein the pre-heat temperature is in the range of 50° C. to 230° C.

13. The image forming method according to claim 11, wherein the pre-heat temperature is in the range of 140° C. to 200° C.

14. An image exposure apparatus used in the image forming method on a planographic printing plate precursor which includes a support having disposed thereon an image recording layer that contains cationically polymerizable compound-encapsulating microcapsules, an acid generator, and a light-to-heat conversing agent, comprising:
a holding member that holds an attachable planographic printing plate precursor to the apparatus;
a pre-heating unit that heats the held planographic printing plate precursor to bring to a pre-heat temperature by applying thermal or electromagnetic energy from a linearly extending or two-dimensionally spreading heat supplying unit; and
an irradiating unit that irradiates the held planographic printing plate precursor with an infrared beam to form an image in the image recording layer of the planographic printing plate precursor.

15. The image exposure apparatus according to claim 14, wherein the pre-heat temperature is in the range of 50° C. to 230° C.

16. The image exposure apparatus according to claim 14, wherein the pre-heat temperature is in the range of 140° C. to 200° C.

17. An image forming method on a planographic printing plate precursor including a support having disposed thereon an image recording layer that contains radical-polymerizable compound-encapsulating microcapsules, a radical generating agent, and a light-to-heat conversing agent, comprising the steps of:
carrying out pre-heating of the planographic printing plate precursor to bring to a pre-heat temperature; and
irradiating the pre-heated planographic printing plate precursor with an infrared beam to form an image in the image recording layer of the planographic printing plate precursor.

18. The image forming method according to claim 17, wherein the pre-heat temperature is in the range of 50° C. to 230° C.

19. The image forming method according to claim 17, wherein the pre-heat temperature is in the range of 140° C. to 200° C.

20. An image exposure apparatus used in the image forming method on a planographic printing plate precursor which includes a support having disposed thereon an image recording layer that contains radical-polymerizable compound-encapsulating microcapsules, a radical generating agent, and a light-to-heat conversing agent, comprising:
a holding member that holds an attachable planographic printing plate precursor to the apparatus;
a pre-heating unit that heats the held planographic printing plate precursor to bring to a pre-heat temperature by applying thermal or electromagnetic energy from a linearly extending or two-dimensionally spreading heat supplying unit; and
an irradiating unit that irradiates the held planographic printing plate precursor with an infrared beam to form an image in the image recording layer of the planographic printing plate precursor.
